(19) United States
(12) Patent Application Publication
(10) Pub. No.: US 2011/0242339 A1
(43) Pub. Date: Oct. 6, 2011

(54) IMAGE PROCESSING APPARATUS, IMAGE PROCESSING METHOD, AND IMAGE PROCESSING PROGRAM

(75) Inventor: Nobuhiro OGAWA, Tokyo (JP)

(73) Assignee: Sony Corporation, Tokyo (JP)

(21) Appl. No.: 13/038,560

(22) Filed: Mar. 2, 2011

(30) Foreign Application Priority Data
Mar. 31, 2010 (JP) 2010-082045

(51) Int. Cl. H04N 5/228

(52) U.S. Cl. 348/208.4; 348/E05.031

(57) ABSTRACT

An image processing apparatus includes: a matching processing unit calculating positions of center coordinates of all video data forming one frame image of multi-viewpoint video data with respect to coordinates of the origin of the one frame image using at least two pieces of video data forming the one frame image, and generating focus information as the calculation result; a motion vector detection unit detecting a motion vector, which indicates an overall motion of the one frame image, using one piece of video data of at least two pieces of video data forming the one frame image; a motion component separation processing unit separating motion components of the one frame image using the generated focus information and the detected motion vector; and a correction unit correcting all of the video data forming the one frame image using the motion components separated by the motion component separation processing unit.

### BACKGROUND OF THE INVENTION

1. Field of the Invention

The present invention relates to an image processing apparatus, an image processing method, an image processing program, and a recording medium, and more particularly, to an image processing apparatus editing multi-viewpoint video data photographed by, for example, an imaging apparatus.

2. Description of the Related Art

In the past, there was widely known an image apparatus that mounted a sensor such as an acceleration sensor and corrected camera shaking by moving an optical element such as a lens to compensate the camera shaking caused by a user (for example, see http:/dspace.wul.waseda.ac.jp/dspace/bitstream/2065/5323/3/Honbun-4189.pdf (Research on Core Technologies for the improvement of Vulnerabilities in Video Systems) Mitsuaki OSHIMA).

In an image apparatus, a CCD (Charge Coupled Device) using a global shutter method is generally used as an imaging device. The CCD is configured to transmit data corresponding to one frame immediately.

In recent years, however, many imaging apparatuses utilize a CMOS (Complementary Metal Oxide Semiconductor) using a focal plane shutter method since there is an advantage in terms of cost or the like.

Since the CMOS transmits data line by line, temporal imaging timing slightly deviates in the frame. Therefore, for frame image data photographed by the CMOS, so-called focal plane distortion may occur in a subject when an imaging apparatus is moved due to camera shaking or user's intended motion (hereinafter, referred to as “camera work”).

In order to resolve this problem, there was suggested an imaging apparatus that corrects the focal plane distortion in the frame image data (for example, see Japanese Unexamined Patent Application Publication No. 2008-78808)

### SUMMARY OF THE INVENTION

In the imaging apparatus having a function of correcting the above-mentioned camera shaking, the camera shaking is reduced by off-setting a part of the camera shaking to prevent over-correction being emitted by a control system. That is, in the imaging apparatus, the influence of the camera shaking may be abated in the video data, but some influence of the camera shaking still remains in the imaged video data. Accordingly, it is desirable to further reduce the influence of the camera shaking by a post-process after the imaging.

In the imaging apparatus, the amount of motion (hereinafter, referred to as a “camera motion”) of the imaging apparatus itself may not be detected in the post-process. Since it is necessary for the imaging device to be divided in the method disclosed in Japanese Unexamined Patent Application Publication No. 2008-78808, this method may not applied to the post-process.

Accordingly, in an image processing apparatus, a camera motion component is calculated based on a motion vector detected from the video data and a camera shaking amount is calculated from the camera motion. As described above, however, the focal plane distortion occurs due to the camera shaking of an imaging apparatus.

In this case, in the image processing apparatus, a problem may arise due to the fact that the camera motion component may not be calculated with high accuracy due to the influence of the focal plane distortion on the motion vector and the quality of the frame image data may not be improved.

The method of correcting the camera shaking of the video data according to the related art is used for single-viewpoint video data. Therefore, when multi-viewpoint video data is photographed by an imaging apparatus and the method of correcting the camera shaking according to the related art is applied to the photographed multi-viewpoint video data without any modification, a problem may arise due to the fact that the desired video data may not be acquired.

In the light of the foregoing, it is desirable to provide a novel and improved image processing apparatus, a novel and improved image processing method, and a novel and improved image processing program capable of improving the quality of multi-viewpoint video data.

According to an embodiment of the invention, there is provided an image processing apparatus including: a matching processing unit calculating positions of center coordinates of all video data forming one frame image of multi-viewpoint video data with respect to coordinates of the origin of the one frame image using at least two pieces of video data forming the one frame image, and generating focus information as the calculation result; a motion vector detection unit detecting a motion vector, which indicates an overall motion of the one frame image, using one piece of video data of at least two pieces of video data forming the one frame image; a motion component separation processing unit separating motion components of the one frame image using the focus information generated by the matching processing unit and the motion vector detected by the motion vector detection unit; and a correction unit correcting all of the video data forming the one frame image using the motion components separated by the motion component separation processing unit.

The matching processing unit may calculate positions of center coordinates of all video data forming the one frame image with respect to the coordinates of the origin of the one frame image using central video data of at least two pieces of video data forming the one frame image and video data adjacent to the central video data, and may generate the focus information as the calculation result.

The matching processing unit may calculate positions of center coordinates of all the video data forming the one frame image with respect to the coordinates of the origin of the one frame image, using all of the video data forming the one frame image, and may generate the focus information based on a positional relationship between the calculation result and all of the video data.

The matching processing unit may generate the focus information at a predetermined frame interval.

The matching processing unit may generate the focus information using the motion vector detected by the motion vector detection unit, when a motion amount which is based on the motion vector exceeds a given threshold value.

The matching processing unit may generate the focus information when a scene change detection unit detects a scene change in the video data.

In a case where the video data is encoded, the matching processing unit may generate the focus information, when a picture type of the video data is a predetermined picture type.

The motion component separation processing unit may separate the motion components of the one frame image using a motion vector with the highest reliability among the motion vectors detected by the motion vector detection unit.

The matching processing unit may perform stereo matching using at least two video data forming the one frame image of the multi-viewpoint video data, may calculate a position of center coordinates of the same depth region in all of the video data forming the one frame image with respect to the coordinates of the origin of the one frame image when a depth map is obtained as the result of the stereo matching, and may generate the focus information as the calculation result, the motion component separation processing unit separates motion components of the same depth region using the focus information generated by the matching processing unit and the motion vector detected by the motion vector detection unit, and the correction unit corrects the same depth region in all of the video data forming the one frame image using the motion components separated by the motion component separation processing unit.

The motion component separation processing unit may include a modeling unit modeling the motion vector detected by the motion vector detection unit into a component separation expression, in which a camera motion component and a focal plane distortion component are separated, using unknown component parameters respectively indicating a camera motion which is a motion of a camera and variation amounts of focal plane distortion, and a component calculation unit calculating the camera motion component of the motion vector by calculating the component parameters used in the component separation expression.

The modeling unit may model the motion vector into an expression below.

$$\begin{matrix}( \begin{matrix}{x}_{1} \\ {y}_{1} \\ 1\end{matrix} ) = ( \begin{matrix}{A}_{1} & {A}_{2} & {A}_{0} \\ {B}_{1} & {B}_{2} & {B}_{0} \\ 0 & 0 & 1\end{matrix} ) ( \begin{matrix}{x}_{0} \\ {y}_{0} \\ 1\end{matrix} ) \\ = ( \begin{matrix}1 & 0 & {h}_{c} \\ 0 & 1 & {v}_{c} \\ 0 & 0 & 1\end{matrix} ) ( \begin{matrix}\frac{1}{p} & 0 & 0 \\ 0 & 1 & 0 \\ 0 & 0 & 1\end{matrix} ) ( \begin{matrix}1 & 0 & 0 \\ 0 & e & 0 \\ 0 & 0 & 1\end{matrix} ) ( \begin{matrix}1 & b & 0 \\ 0 & 1 & 0 \\ 0 & 0 & 1\end{matrix} ) \\ ( \begin{matrix}1 & 0 & h \\ 0 & 1 & v \\ 0 & 0 & 1\end{matrix} ) ( \begin{matrix}cos θ & - sin θ & 0 \\ sin θ & cos θ & 0 \\ 0 & 0 & 1\end{matrix} ) ( \begin{matrix}s & 0 & 0 \\ 0 & s & 0 \\ 0 & 0 & 1\end{matrix} ) ( \begin{matrix}p & 0 & 0 \\ 0 & 1 & 0 \\ 0 & 0 & 1\end{matrix} ) \\ ( \begin{matrix}1 & 0 & - {h}_{c} \\ 0 & 1 & - {v}_{c} \\ 0 & 0 & 1\end{matrix} ) ( \begin{matrix}{x}_{0} \\ {y}_{0} \\ 1\end{matrix} )\end{matrix} \qquad ( 1 )$$

The correction unit may include a camera work component calculation unit calculating a camera work component indicating a user's intended motion of a camera based on a camera motion component, a shaking amount calculation unit calculating a shaking amount by subtracting the camera work component from the camera motion component, a correction vector generation unit generating a correction vector used to correct shaking in the motion vector based on the shaking amount calculated by the shaking amount calculation unit, and a motion compensation unit applying the correction vector generated by the correction vector generation unit to the motion vector.

The modeling unit may express the camera motion component and a focal plane distortion component as a determinant.

The correction vector generation unit may generate a determinant including an inverse matrix of the shaking amount as the correction vector.

The correction unit may further includes a focal plane distortion correction amount calculation unit which calculates a focal plane distortion correction amount used to correct the frame image based on the focal plane distortion component calculated by the component calculation unit. The correction vector generation unit may generate a determinant including an inverse matrix of the focal plane distortion correction amount as the correction vector.

The modeling unit may multiply an origin correction matrix, which moves the origin based on the focus information, before the rotation element and multiplies an origin correction inverse matrix, which returns the origin to a position before the movement, after the rotation element.

An aspect ratio correction matrix, which changes an aspect ratio of pixels to 1:1, may be multiplied before the rotation element and an aspect ratio correction inverse matrix, which returns the pixels to a base aspect ratio, may be multiplied after the rotation element.

On the assumption that the correction vector is Vc, the origin correction matrix is C, the aspect ratio correction matrix is P, an inverse matrix of the shaking amount is Mₛ⁻¹, an inverse matrix of the focal plane distortion correction amount is F⁻¹, the origin correction inverse matrix is C⁻¹, and the aspect ratio correction inverse matrix is P⁻¹, the correction vector generation unit generates the correction vector by an expression below.

Vc=C⁻¹P⁻¹Mmₛ⁻¹F⁻¹PC (2)

According to another embodiment of the invention, there is provided an image processing method including the steps of: calculating positions of center coordinates of all video data forming one frame image of multi-viewpoint video data with respect to coordinates of the origin of the one frame image using at least two pieces of video data forming the one frame image, and generating focus information as the calculation result; detecting a motion vector, which indicates an overall motion of the one frame image, using one piece of video data of at least two pieces of video data forming the one frame image; separating motion components of the one frame image using the focus information generated in the step of generating the focus information and the motion vector detected in the step of detecting motion vector; and correcting all of the video data forming the one frame image using the motion components separated in the step of separating the motion components of the one frame image.

According to still another embodiment of the invention, there is provided an image processing program causing a computer to execute the steps of: calculating positions of center coordinates of all video data forming one frame image of multi-viewpoint video data with respect to coordinates of the origin of the one frame image using at least two pieces of video data forming the one frame image, and generating focus information as the calculation result; detecting a motion vector, which indicates an overall motion of the one frame image, using one piece of video data of at least two pieces of video data forming the one frame image; separating motion components of the one frame image using the focus information generated in the step of generating the focus information and the motion vector detected in the step of detecting motion vector; and correcting all of the video data forming the one frame image using the motion components separated in the step of separating the motion components of the one frame image.

According to the embodiments of the invention, the quality of the multi-viewpoint video data can be improved.

### BRIEF DESCRIPTION OF THE DRAWINGS

FIG. 1 is a schematic diagram illustrating the outer appearance configuration of an image processing terminal.

FIG. 2 is a schematic diagram illustrating a relationship between a camera motion and a camera work.

FIG. 3 is a schematic diagram illustrating the configuration of an image processing unit according to a first embodiment.

FIG. 4 is a schematic diagram illustrating an input frame.

FIG. 5 is a schematic diagram illustrating linear interpolation in a motion compensation process.

FIGS. 6A and 6B are schematic diagrams illustrating generation of a global motion vector.

FIGS. 7A and 7B are schematic diagrams illustrating a matching process.

FIG. 8 is a flowchart illustrating the matching process.

FIG. 9 is a schematic diagram illustrating definition directions determined with reference to a camcorder.

FIGS. 10A to 10C are schematic diagrams illustrating focal plane distortion caused due to camera shaking in a horizontal direction.

FIGS. 11A to 11C are schematic diagrams illustrating focal plane distortion caused due to camera shaking in a vertical direction.

FIGS. 12A to 12C are schematic diagrams illustrating a variation in an image due to camera shaking.

FIGS. 13A to 13C are schematic diagrams illustrating rotation central coordinates.

FIGS. 14A to 14C are schematic diagrams illustrating motion of a camera when elbows are set as a reference.

FIGS. 15A and 15B are schematic diagrams illustrating conversion of an aspect ratio.

FIG. 16 is a schematic diagram illustrating the configuration of a component separation model.

FIG. 17 is a flowchart illustrating a component calculation process.

FIG. 18 is a flowchart illustrating a filtering process.

FIGS. 19A and 19B are schematic diagrams illustrating a focal plane distortion component and an accumulative value of the focal plane distortion component.

FIG. 20 is a schematic diagram illustrating a relationship between a frame image and a motion vector.

FIGS. 21A and 21B are schematic diagrams illustrating adjustment of the focal plane distortion component.

FIG. 22 is a flowchart illustrating a sequence of an FP distortion correction amount calculation process according to the first embodiment.

FIGS. 23A and 23B are schematic diagrams illustrating an LPF characteristic.

FIG. 24 is a schematic diagram illustrating an appropriate angle range.

FIG. 25 is a flowchart illustrating a sequence of a trapezoid distortion estimation process.

FIG. 26 is a flowchart illustrating a correction vector generation process.

FIG. 27 is a schematic diagram illustrating the configuration of an image processing unit according to another embodiment.

FIGS. 28A and 28B are schematic diagrams illustrating a matching process.

FIGS. 29A and 29B are schematic diagrams illustrating a depth map.

### DESCRIPTION OF THE PREFERRED EMBODIMENTS

Hereinafter, preferred embodiments of the invention will be described in detail with reference to the accompanying drawings. In the specification and the drawings, the same reference numerals are given to the constituent elements having substantially the same function and the description thereof will not be repeated.

The description will be made in the following order.

1. First Embodiment

2. Second Embodiment

### 1. First Embodiment

### 1-1. Overall Configuration

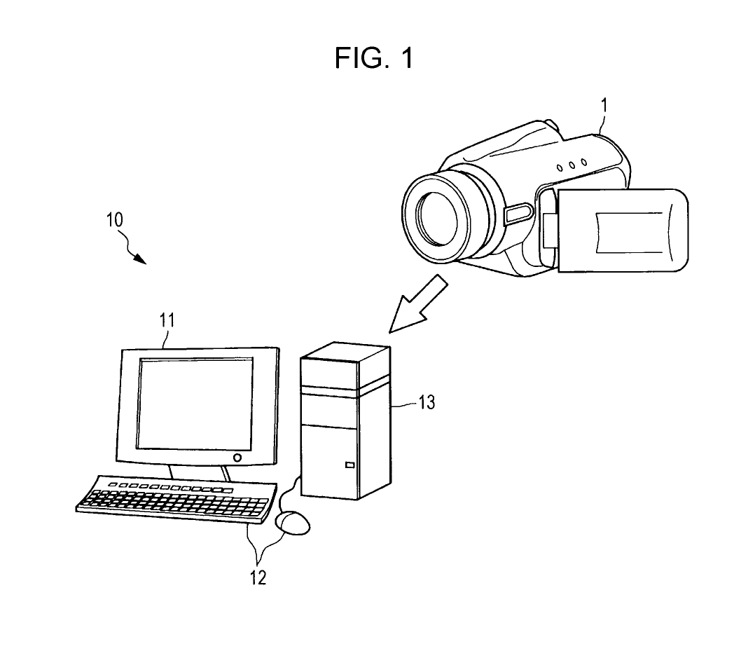

As shown in FIG. 1, an image processing terminal 10 includes a monitor unit 11, an operation unit 12, and image processing unit 13. The image processing terminal 10 supplies frame image data supplied from a camcorder 1 to the image processing unit 13.

The image processing unit 13 detects a global motion vector GMV indicating a motion vector of the entire frame image between the frame images with regard to frame image data formed form the frame image. In this embodiment, it is assumed that the camcorder 1 photographs multi-viewpoint video data, and at least two pieces of video data forming one frame image of video data are sequentially supplied to the image processing unit 13 frame by frame.

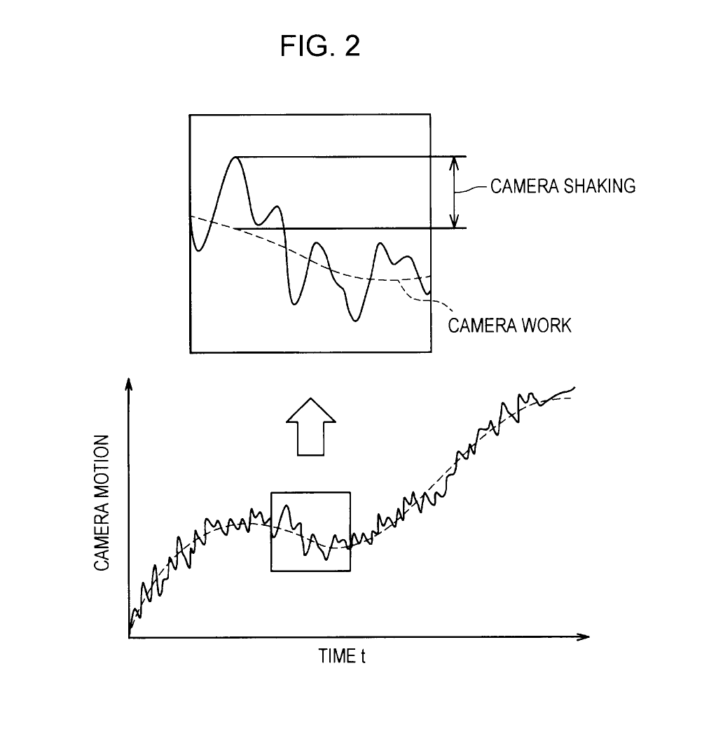

As described above, the global motion vector GMV includes not only a movement of a camera (hereinafter, referred to as a “camera motion”) but also a focal plane distortion component CF which is a variation amount of focal plane distortion. As shown in FIG. 2, the camera motion includes not only a user's intended motion (hereinafter, referred to as “camera work”) but also shaking (hereinafter, referred to as “camera shaking”), which is a user's unintended motion.

Here, the image processing unit 13 removes the focal plane distortion component CF from the global motion vector GMV and then corrects the camera shaking.

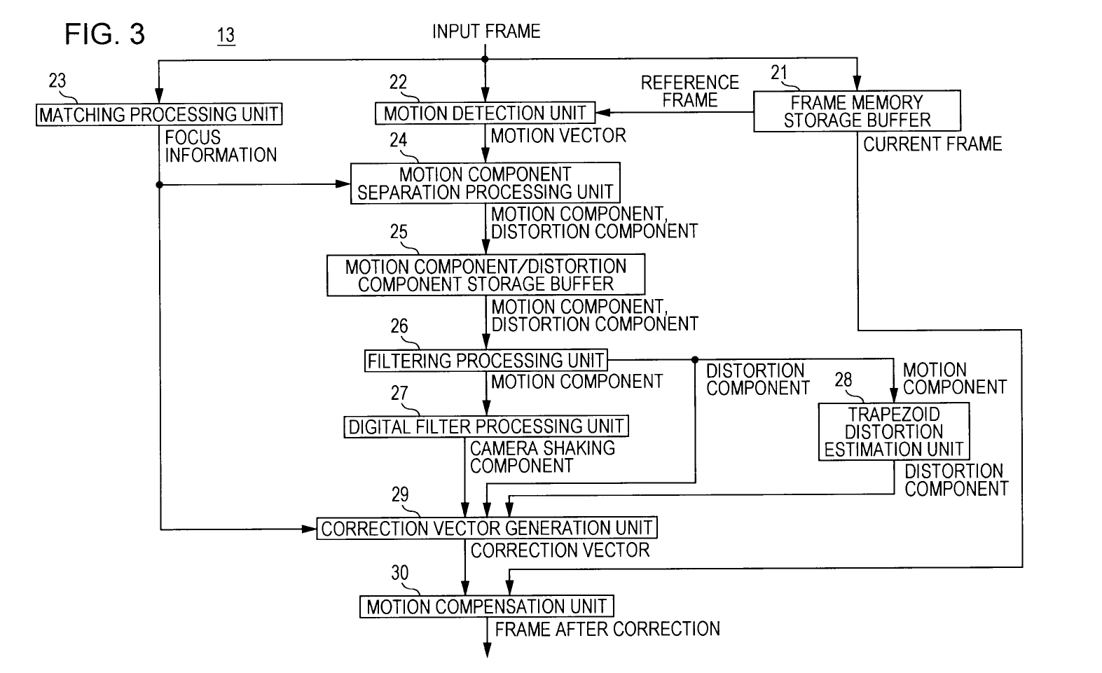

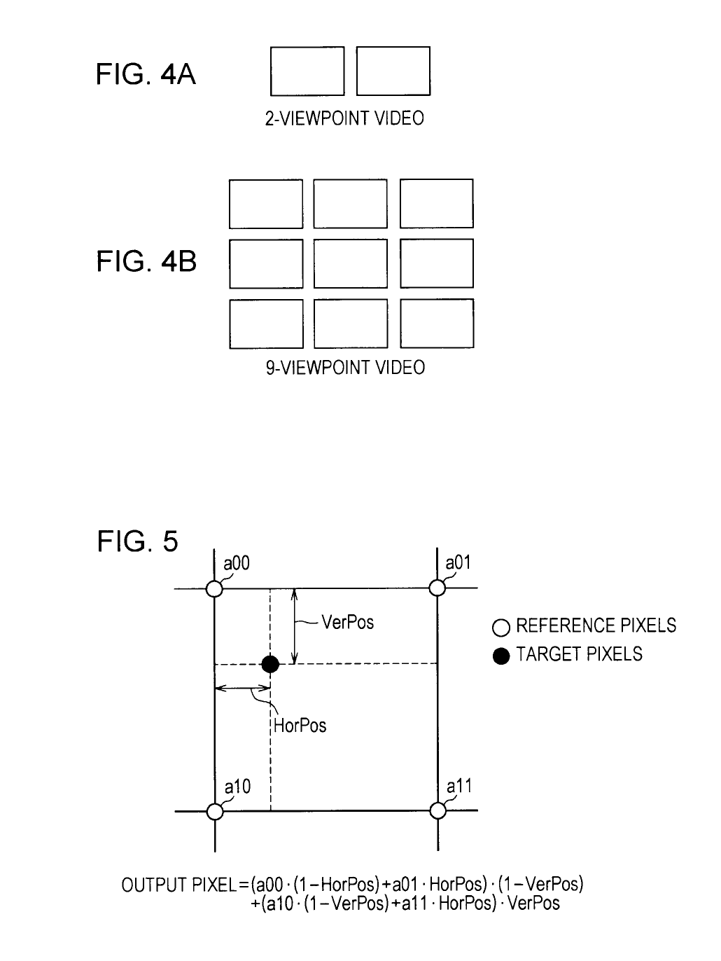

As shown in FIG. 3, the image processing unit 13 sequentially supplies at least two or more pieces of video data forming one frame image to a frame memory storage buffer 21, a motion detection unit 22, and a matching processing unit 23 by frame image by frame image. In this embodiment, the camcorder 1 photographs video data of N by M (horizontal N lines and vertical M lines) viewpoints and N by M pieces of video data forming one frame image of the video data are sequentially supplied to the image processing unit 13 frame by frame. For example, when the camcorder 1 photographs video data of 2 by 1 viewpoints, as shown in FIG. 4A, two pieces of video data forming one frame image of the video data are sequentially supplied to the image processing unit 13 frame by frame. For example, when the camcorder 1 photographs video data of 3 by 3 viewpoints, as shown in FIG. 4B, nine pieces of video data forming one frame image of the video data are sequentially supplied to the image processing unit 13 frame by frame.

The motion detection unit 22 calculates a global motion vector GMV indicating an overall motion vector of the frame image by a motion detection process described below, from one piece of video data (hereinafter, referred to as “processing target video data”) of at least two pieces of video data forming a frame image to be processed and one piece of video data (hereinafter, referred to as “reference video data”) of the same viewpoint as that of the processing target video data of at least two pieces of video data forming an immediately previous reference frame image supplied from a frame memory storage buffer 21. At this time, the motion detection unit 22 generates reliability information indicating the reliability of the global motion vector GMV and supplies both the reliability information and the global motion vector GMV to a motion component separation processing unit 24.

The matching processing unit 23 performs a matching process described below to acquire a relative position relationship between the video data of all viewpoints in vertical and horizontal directions in at least two pieces of video data forming the processing target frame image, and then outputs focus information described below to the motion component separation processing unit 24 and a correction vector generation unit 29.

The motion component separation processing unit 24 performs a component separation process described below to separate the global motion vector GMV into a camera motion component CM indicating a camera motion amount and a focal plane distortion component CF indicating a variation amount of focal plane distortion.

The motion component separation processing unit 24 supplies the camera motion component CM, the focal plane distortion component CF, and the reliability information to a motion component distortion component storage buffer 25. The motion component distortion component storage buffer 25 temporarily stores the camera motion component CM, the focal plane distortion component CF, and the reliability information according to, for example, FIFO (First In First Out).

A filtering processing unit 26 performs a filtering process described below to filter the camera motion component CM and the focal plane distortion component CF based on the reliability information.

The filtering processing unit 26 supplies the filtered camera motion component CM to a digital filter processing unit 27 and a trapezoid distortion estimation unit 28. The filtering processing unit 26 supplies the filtered focal plane distortion component CF to a correction vector generation unit 29.

The filtering processing unit 26 performs an FP distortion correction amount calculation process (which is described below in detail) to generate an FP distortion correction amount CFc which is a correction amount for the focal plane distortion, and then supplies the FP distortion correction amount CFc to the correction vector generation unit 29.

The digital filter processing unit 27 performs a camera work amount calculation process, which is described below, on the camera motion component CM supplied from the filtering processing unit 26 to calculate a camera work amount, and then supplies the camera work amount to the correction vector generation unit 29.

The trapezoid distortion estimation unit 28 performs a trapezoid distortion estimation process described below to calculate a trapezoid distortion amount A used for removing the influence of the trapezoid distortion from the frame image data, and then supplies the trapezoid distortion amount A to the correction vector generation unit 29.

The correction vector generation unit 29 performs a correction vector generation process on all video data of at least two pieces of video data forming the processing target frame image to generate a correction vector Vc based on the camera work amount, the FP distortion correction amount CFc, and the trapezoid distortion amount A, and then supplies the correction vector Vc to a motion compensation unit 30. The correction vector Vc is a vector used for correcting the camera shaking, the focal plane distortion, and the trapezoid distortion.

The motion compensation unit 30 performs a motion compensation process by applying the correction vector Vc to a current frame image (a frame image to be currently processed) supplied from the frame memory storage buffer 21. Moreover, the motion compensation unit 30 corrects the camera shaking and the focal plane distortion by segmenting a frame image into pieces with a size smaller than that of the frame image. Therefore, the motion compensation unit 30 performs linear interpolation with a degree of accuracy (for example, ½-pixel accuracy or ¼-pixel accuracy) equal to or less than one image in order to improve a lowered resolution, as shown in FIG. 5.

The motion compensation unit 30 sequentially supplies the frame images subjected to the linear interpolation to the monitor unit 11 (see FIG. 1). As a consequence, the frame images corrected in the camera shaking and the focal plane distortion are sequentially displayed on the monitor unit 11.

Thus, the image processing unit 13 of the image processing terminal 10 is configured to correct the camera shaking, the focal plane distortion, and the trapezoid distortion in the frame image data.

### 1-2. Motion Detection Process

The motion detection unit 22 performs a motion detection process to detect the global motion vector GMV indicating the overall motion of the frame image to be processed from the supplied reference video data and the supplied processing target video data.

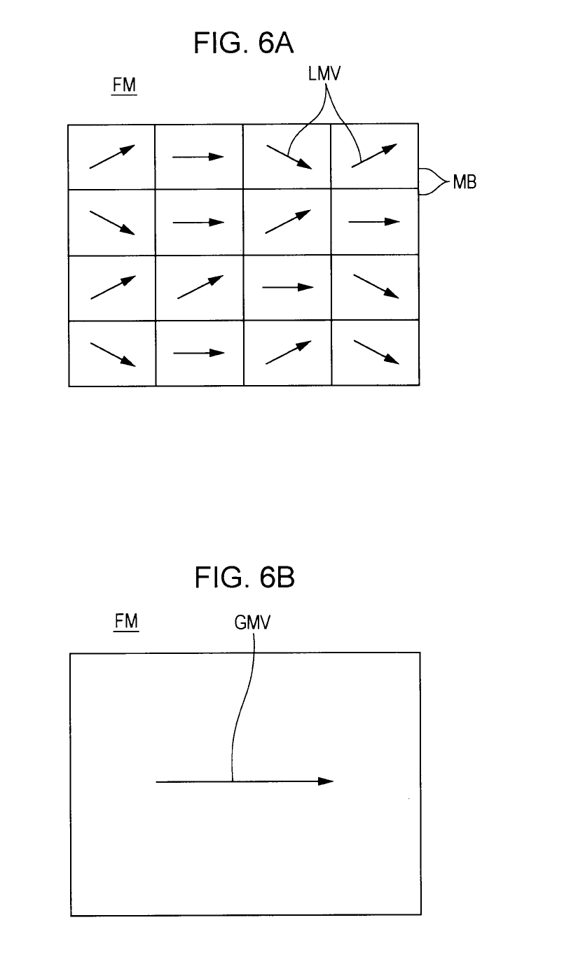

As shown in FIG. 6, the motion detection unit 22 calculates a motion vector (hereinafter, referred to as a “local motion vector LMV”) of the processing target video for the reference video data per pixel block unit with the predetermined number of pixels. For example, the motion detection unit 22 performs block matching on each macro block with 16 by 16 pixels as the pixel block unit to calculate the local motion vector LMV.

At this time, the motion detection unit 22 calculates the global motion vector GMV by weighting the local motion vector LMV using various reliability indexes indicating reliability of the local motion vector LMV.

Examples of the reliability index include the size of the local motion vector LMV, a difference absolute value sum, a dispersion value of block formation pixel values, a covariance value calculated from a constituent pixel value of a corresponding block between the reference video data and the processing target video data, and a combination thereof. A method of calculating the global motion vector GMV is disclosed in detail in Japanese Unexamined Patent Application Publication No. 2007-230053 and Japanese Unexamined Patent Application Publication No. 2007-230054.

When the reliability index is high, the reliability of the local motion vector LMV is said to be high. Moreover, when the reliability of the local motion vector LMV is high, the reliability of the global motion vector GMV is also said to be high.

Therefore, the motion detection unit 22 utilizes the reliability index in the processing target video data as reliability information regarding the global motion vector GMV corresponding to the processing target video data.

Thus, the motion detection unit 22 calculates the global motion vector GMV indicating the overall motion of the frame image to be processed based on the local motion vector LMV calculated for each macro block. At this time, the motion detection unit 22 utilizes the reliability of the local motion vector LMV as the reliability information regarding the global motion vector GMV.

### 1-3. Matching Process

The matching processing unit 23 performs the matching process to acquire the relative position relationship between the video data of all viewpoints in vertical and horizontal directions in at least two pieces of video data forming the processing target frame image. A method of the matching processing is disclosed in Japanese Unexamined Patent Application Publication No. 2009-176085.

The matching processing unit 23 can acquire the relative position relationship with the videos (video data) of the adjacent viewpoints by performing the matching process. For example, in stereo matching, a result can very often be obtained in each region with the same depth by performing matching on each block or pixel. In this embodiment, a matching result of a background, that is, the innermost region is used.

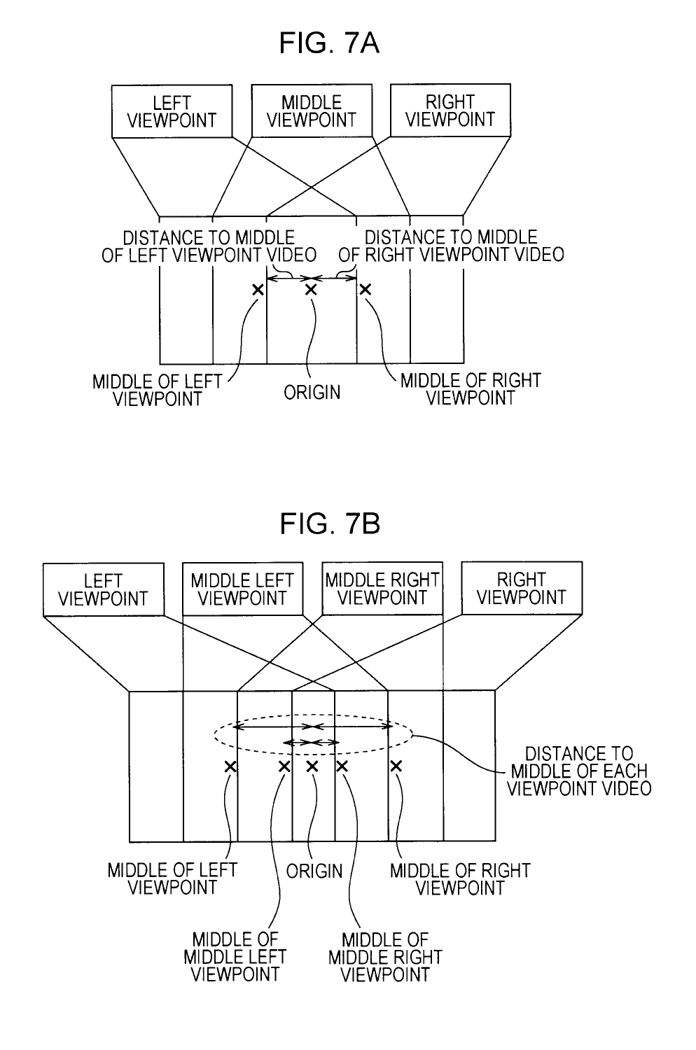

When the relative position relationship between the video data of all viewpoints (video data) in the vertical and horizontal directions can be acquired, a distance between the origin and a video (video data) of each viewpoint is calculated as a pixel value. The calculated distances are a distance a left viewpoint video (video data) between the origin and the middle of the left viewpoint image (video data) shown in FIG. 7A, a distance between the origin and the middle of the right viewpoint image (video data) shown in FIG. 7A, and distances between the origin and the middles of the respective viewpoint images (video data) shown in FIG. 7B. When the number of viewpoints is odd, as shown in FIG. 7A, the origin is set to the coordinates of the middle position of the middle viewpoint image (video data). When the number of viewpoints is even, the origin is set to the coordinates of the middle position of the middle two viewpoint images (video data). In addition, this concept is applied to set the origin in both the vertical and horizontal direction. Each pair of distances between the origin and the respective viewpoint image (video data) is output as focus information.

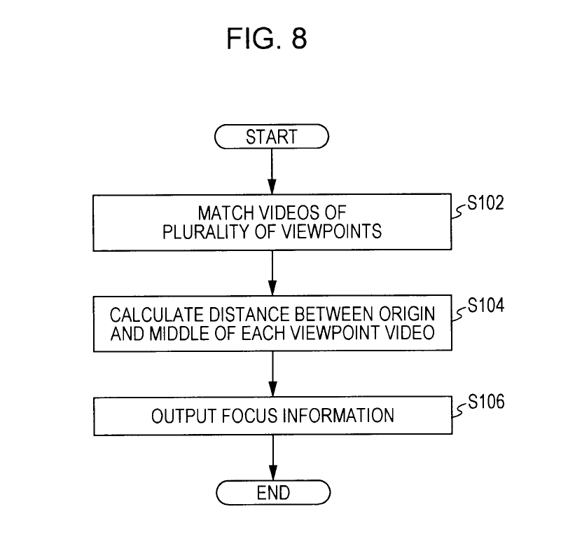

Next, a matching process executed according to an image processing program will be described with reference to the flowchart of FIG. 8. This matching process corresponds to the above-described matching process.

When at least two pieces of video data forming the processing target frame image are supplied, the matching processing unit 23 of the image processing unit 13 starts the matching process and the process proceeds to step S102.

In step S102, the matching processing unit 23 matches the videos (video data) of the plurality of viewpoints to acquire the relative position relationship between the video data of all viewpoints in the vertical and horizontal directions, and then the process proceeds to step S104.

In step S104, the matching processing unit 23 determines the origin, as described above, and calculates the distance between the origin and the middle of the video (video data) of each viewpoint. Then, the process proceeds to step S106.

In step S106, the matching processing unit 23 outputs the pair of distances between the origin and the videos (video data) of the respective viewpoints as the focus information to the motion component separation processing unit 24 and the correction vector generation unit 29, and then the process proceeds to the end step to end the matching process.

### 1-4. Motion Component Separation Process

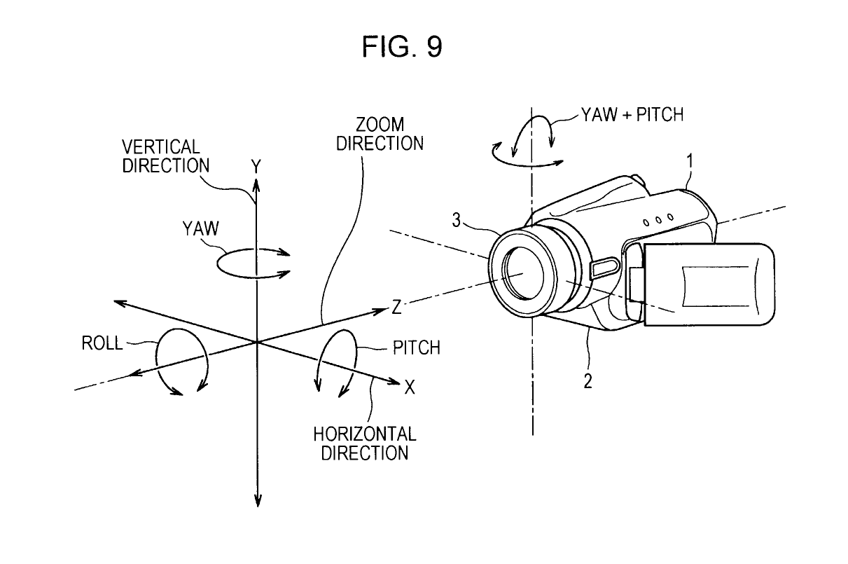

First, the camcorder 1 serving as an imaging apparatus and directions determined using the camcorder 1 as a reference will be described with reference to FIG. 9.

When an image photographed by the camcorder 1 is used as a reference, the X-axis direction in which a subject moves horizontally when the camcorder 1 moves is referred to as a horizontal direction and the Y-axis direction in which a subject moves vertically when the camcorder 1 moves is referred to as a vertical direction. In addition, the Z-axis direction in which a subject zooms when the camcorder 1 moves is referred to as a zoom direction.

When a direction rotated about the X axis is referred to as a pitch direction, a direction rotated about the Y axis is referred to as a yaw direction, and a direction rotated about the Z axis is referred to as a roll direction. Moreover, in a frame image, a direction in which a subject moves when the camcorder 1 moves in the horizontal direction is referred to as a transverse direction and a direction in which a subject move when the camcorder 1 moves in the vertical direction is referred to as a longitudinal direction.

The image processing unit 13 of the image processing terminal 10 allows the motion component separation processing unit 24 to perform a motion component separation process. The motion component separation processing unit 24 processes only the processing target video data. Here, the global motion vector GMV indicating the overall motion of the frame image includes various components. Therefore, when the components are all modeled, the processing load of the image processing unit 13 increases.

Accordingly, the image processing unit 13 according to this embodiment considers the global motion vector GMV to include only the camera motion component CM indicating the motion of a camera and the focal plane distortion component CF indicating the variation amount of the focal plane distortion.

The motion component separation processing unit 24 of the image processing unit 13 generates a component separation expression by applying the global motion vector GMV to a component separation model that separates the global motion vector GMV into the camera motion component CM and the focal plane distortion component CF using known component parameters. The motion component separation processing unit 24 is configured to calculate the camera motion component CM and the focal plane distortion component CF by calculating the component parameters of the component separation expression.

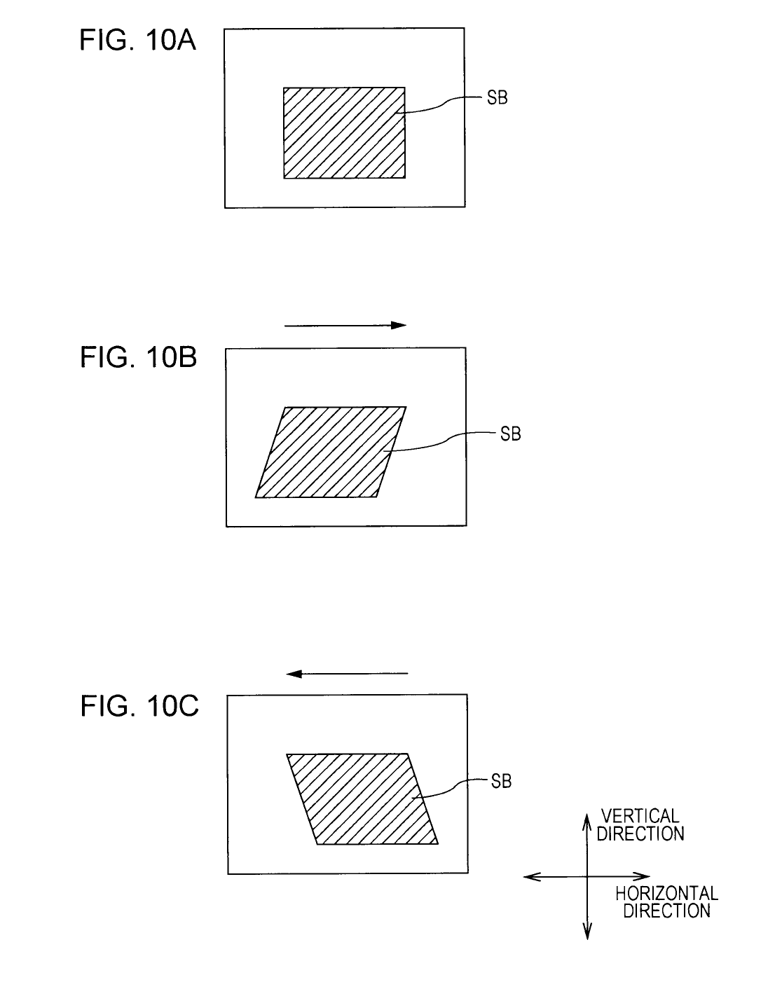

For example, when a rectangular subject SB is photographed, as shown in FIG. 10A, and the camcorder 1 moves in the horizontal direction (indicated by an arrow), the subject SB is deviated in the upper and lower portions with respect to the frame image in the transverse direction and thus is distorted into a parallelogram shape due to the above-described focal plane distortion, as shown in FIGS. 10B and 10C.

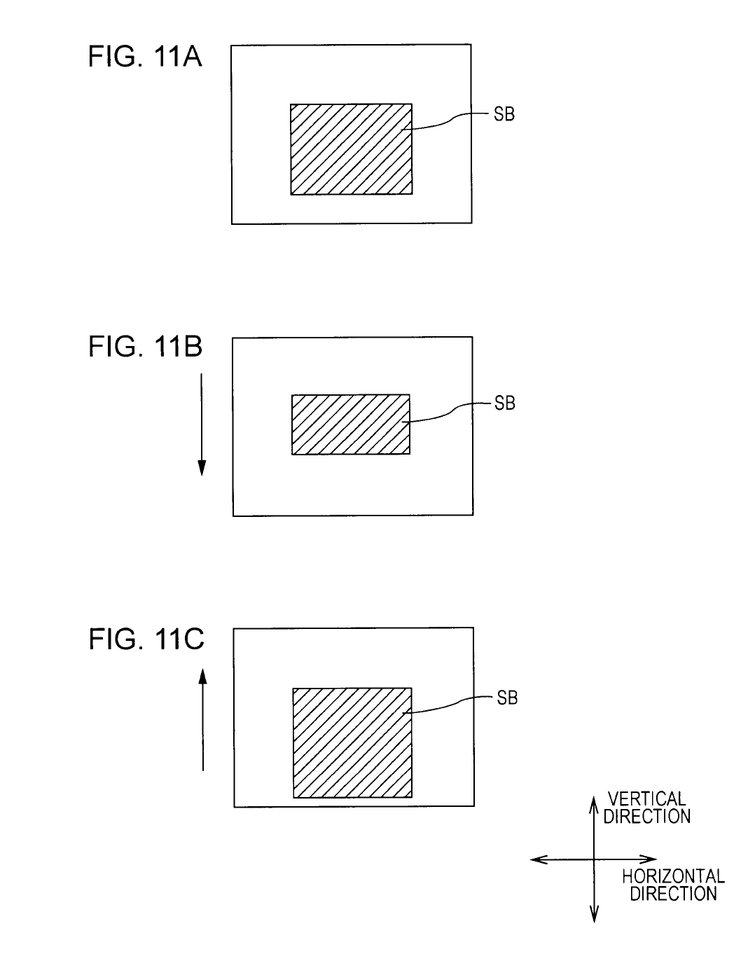

For example, when the rectangular subject SB is photographed, as shown in FIG. 11A, and the camcorder 1 moves in the vertical direction (indicated by an arrow), as shown in FIGS. 11B and 11C, the subject SB is deviated in the upper and lower portions in the longitudinal direction with respect to the frame image and thus is zoomed in the vertical direction.

Accordingly, the image processing unit 13 models the focal plane distortion component CF by using an FP distortion longitudinal zoom component EFa and an FP distortion parallelogram component EFb, as shown in Expression (1). In this expression, e denotes a component parameter indicating zoom of the longitudinal direction and b denotes a component parameter indicating the degree of distortion of the parallelogram.

$$( \begin{matrix}1 & 0 & 0 \\ 0 & e & 0 \\ 0 & 0 & 1\end{matrix} ) ( \begin{matrix}1 & b & 0 \\ 0 & 1 & 0 \\ 0 & 0 & 1\end{matrix} ) \qquad ( 1 )$$

In general, the camera motion component CM includes linear transform and rotation transform. The linear transform includes a translation element indicating a translation speed at which the subject SB moves in the horizontal and vertical directions and a zoom element indicating a zoom speed at which the subject SB zooms in and out. The rotation transform includes a rotation element indicating an angle variation of three directions: the yaw direction, the pitch direction, and the roll direction.

When the focal plane distortion component CF is modeled into the translation element, the zoom element, and the rotation element indicating an angle variation of the three directions, the focal plane distortion component CF is expressed as projection transform, as in Expression (2).

$$( \begin{matrix}{x}_{1} \\ {y}_{1} \\ 1\end{matrix} ) = \frac{1}{{c}_{1} x + {c}_{2} x + {c}_{0}} ( \begin{matrix}{a}_{1} & {a}_{2} & {a}_{0} \\ {b}_{1} & {b}_{2} & {b}_{0} \\ {c}_{1} & {c}_{2} & {c}_{0}\end{matrix} ) ( \begin{matrix}{x}_{0} \\ {y}_{0} \\ 1\end{matrix} ) \qquad ( 2 )$$

However, since the projection transform is not a linear transform expression, the projection transform is not solved by the least-square method. For example, it is necessary to use the steepest descent method. This steepest descent method results in not only a false solution but also an increase in a processing amount.

In the first embodiment, it is assumed that frame image data photographed by the camcorder 1 with the configuration described below is supplied.

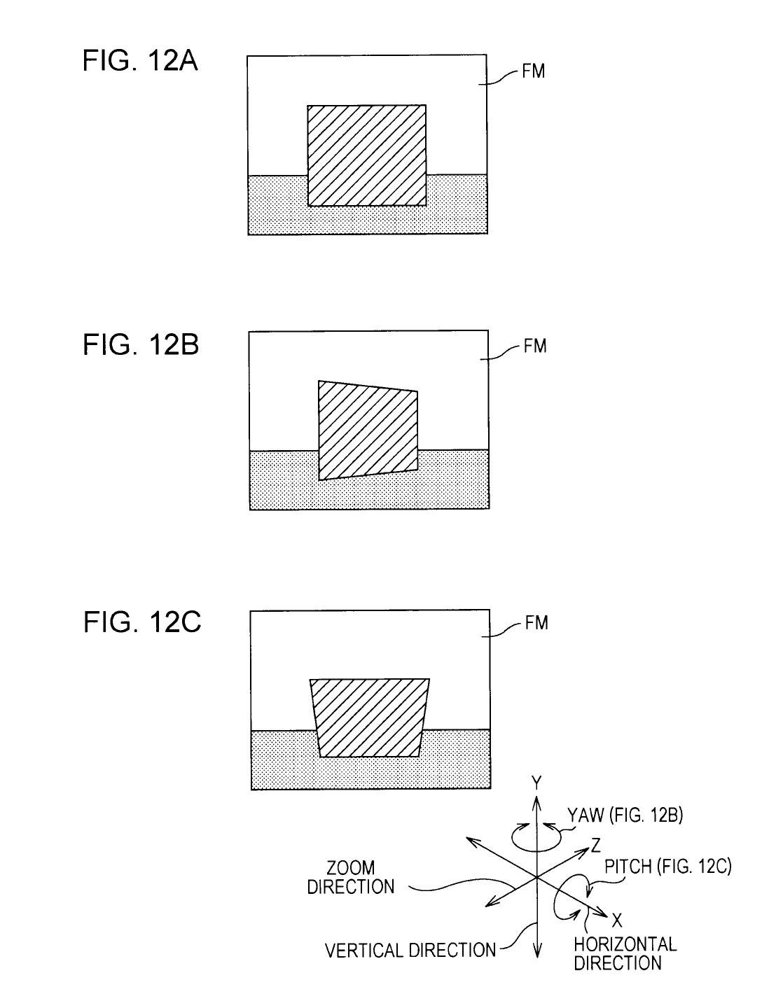

As shown in FIGS. 12A to 12C, the subject SB in a frame image FM photographed as in FIG. 12A varies when the camcorder 1 moves in the yaw direction and the pitch direction with respect to the frame image FM. The arrows shown in the right side of FIGS. 12A to 12C are shown with reference to the camcorder 1.

As shown in FIGS. 12B and 12C, a positional relationship between a lens unit 3 and the subject SB varies when the camcorder 1 moves. Therefore, it can be understood that the position and the angle of the subject SB in the frame image FM vary with respect to in the camcorder 1.

For example, when the position of the subject SB is maintained nearly constantly, the translation element and the zoom element or one of the rotation element and the zoom element may be corrected. However, when this correction is performed, the variation in the angle of the subject SB is not appropriately corrected. Moreover, glimmering or occlusion of a side surface and a trapezoid distortion of a subject (hereinafter, all of which are referred to as “trapezoid distortion”) may occur.

Since the camcorder 1 includes an acceleration sensor (not shown), the camcorder 1 detects a camera motion amount indicating the motion of a camera and calculates user's unintended camera shaking amount indicating from the camera motion amount. Moreover, by moving the lens unit 3 mounted on a main body 2 in the yaw direction and the pitch direction, the camera shaking amount is physically cancelled, thereby suppressing a variation in a positional relationship between the subject SB and the lens unit 3.

Thus, the camcorder 1 suppresses the position and angle variation of the subject SB in the frame image FM due to the camera shaking in the yaw direction and the pitch direction, shown as in FIGS. 12B and 12C.

That is, the angle variation of the subject SB, which occurs due to the movement of the camcorder 1 in the yaw direction and the pitch direction, in the frame image FM is suppressed in the frame image data supplied from the camcorder 1.

Here, the image processing unit 13 of the image processing terminal 10 models the camera motion component CM into Expression (3), by considering that the rotation element EMb is only the angle variation of the roll direction among the camera motion amount.

$$( \begin{matrix}1 & 0 & h \\ 0 & 1 & v \\ 0 & 0 & 1\end{matrix} ) ( \begin{matrix}cos θ & - sin θ & 0 \\ sin θ & cos θ & 0 \\ 0 & 0 & 1\end{matrix} ) ( \begin{matrix}s & 0 & 0 \\ 0 & s & 0 \\ 0 & 0 & 1\end{matrix} ) \qquad ( 3 )$$

Three matrixes in Expression (3) are a translation element EMa, a rotation element EMb, and a zoom element EMc from the left side. In this expression, h is a component parameter indicating translation in the longitudinal direction, v is a component parameter indicating translation in the transverse direction, cos θ and sin θ are component parameters indicating the rotation in the roll direction, and s is a component parameter indicating zoom caused due to a variation in the distance between the camcorder 1 and a subject.

Thus, the image processing unit 13 can apply affine transform in which the global motion vector GMV is expressed by the rotation transform of one direction and linear transform of three directions. As a consequence, the image processing unit 13 can considerably reduce the processing load in calculating the component parameters, since the image processing unit 13 can use a general transform matrix to calculate the component parameters. Moreover, the image processing unit 13 does not calculates a false solution, as in the steepest descent method, since the image processing unit 13 can calculates one given solution.

The motion component separation processing unit 24 performs origin correction and pixel correction on the focal plane distortion component CF and the camera motion component CM.

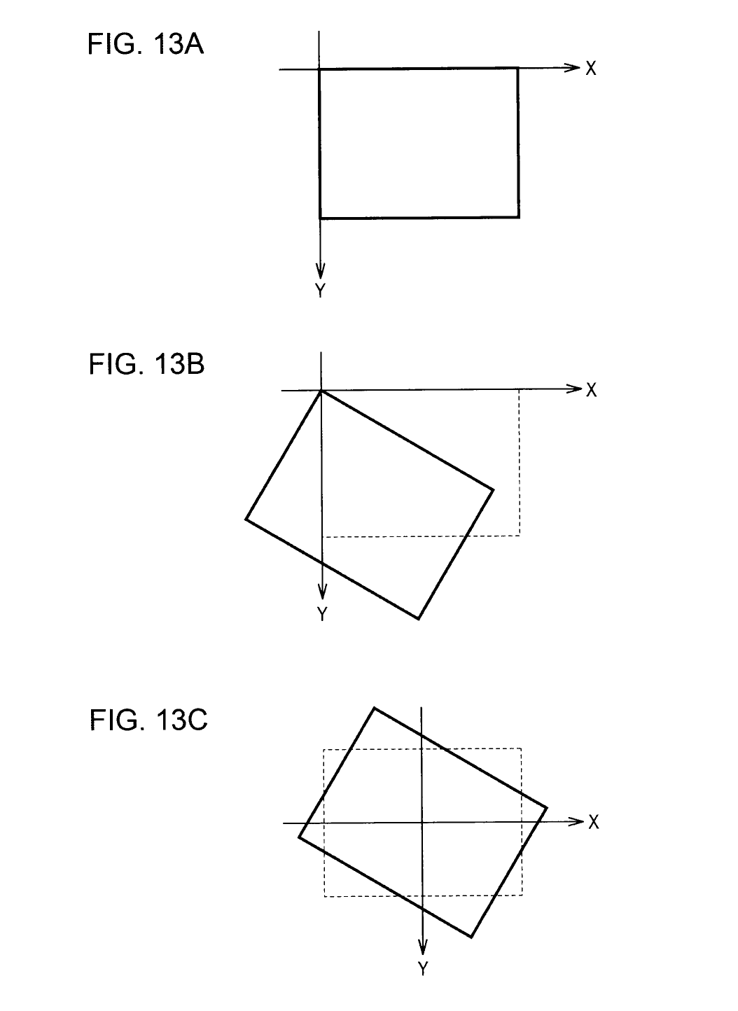

When an image is processed by software, as shown in FIG. 13A, a coordinate system in which the upper left of a frame image is set to the origin is generally used. That is, when this coordinate system is rotated, the frame image is rotated about the pixel at the upper left of the frame image.

However, the camcorder 1 is not rotated about the upper left of the camcorder 1. Since it is considered that a user takes a photograph by locating the subject SB at the center as he could be, as shown in FIG. 13C, it is preferable that the rotation center of the coordinates is set to the center of the frame image.

Accordingly, the motion component separation processing unit 24 moves the origin to the center of the frame image by multiplying the focal plane distortion component CF and the camera motion component CM by an origin correction matrix MC1 in advance, as shown in Expression (4). In this expression, h_{c} denotes ½ of the number of pixels of the frame image in the longitudinal direction and v_{c} denotes ½ of the number of pixels of the frame image in the transverse direction.

$$( \begin{matrix}1 & 0 & - {h}_{c} \\ 0 & 1 & - {v}_{c} \\ 0 & 0 & 1\end{matrix} ) \qquad ( 4 )$$

As shown in Expression (5), the motion component separation processing unit 24 returns the origin to the upper left of the frame image, that is, the center, by multiplying an origin correction inverse matrix MC2 which is an inverse matrix of the origin correction matrix MC1 finally.

$$( \begin{matrix}1 & 0 & {h}_{c} \\ 0 & 1 & {v}_{c} \\ 0 & 0 & 1\end{matrix} ) \qquad ( 5 )$$

Thus, the motion component separation processing unit 24 can calculate the focal plane distortion component CF and the camera motion component CM in the state where the origin is moved to the center of the frame image.

As described above, when the center of the frame image is used as the rotation center of the coordinates, as shown in FIG. 13C, h_{c} denotes ½ of the number of pixels of the frame image in the longitudinal direction and v_{c} denotes ½ of the number of pixels of the frame image in the transverse direction. In this embodiment, h_{c} and v_{c} are the central coordinates of a video (video data) determined by the focus information supplied from the matching processing unit 23 for the video (video data) of each viewpoint.

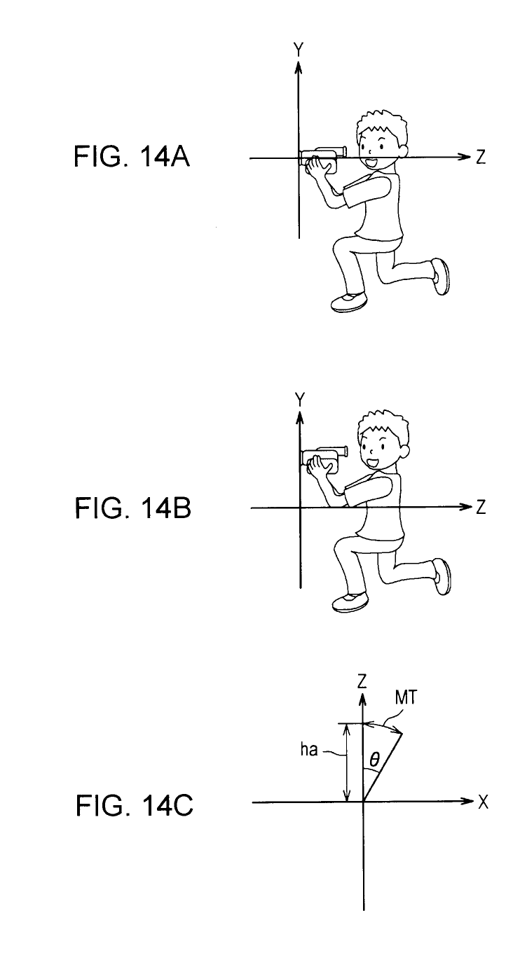

Here, when the user actually taking a photograph does not rotate the camcorder 1 using the center of the frame image being photographed as the rotation axis, as shown in FIG. 14A. The user rather rotates the camcorder 1 using the elbow, wrist, or the like as the rotation axis, as shown in FIG. 14B.

For example, it is assumed that the camcorder 1 is moved only by a movement amount MT by rotating the camcorder 1 using the elbow as the rotation axis, as shown in FIG. 14C. Then, a motion vector decided by the movement amount MT can be expressed as Expression (6), when the distance between the elbow used as the rotation axis to the center of the frame image photographed in the camcorder 1 is ha.

$$( \begin{matrix}1 & 0 & 0 \\ 0 & 1 & h \\ 0 & 0 & 1\end{matrix} ) ( \begin{matrix}cos θ & - sin θ & 0 \\ sin θ & cos θ & 0 \\ 0 & 0 & 1\end{matrix} ) ( \begin{matrix}1 & 0 & 0 \\ 0 & 1 & - h \\ 0 & 0 & 1\end{matrix} ) = ( \begin{matrix}cos θ & - sin θ & h sin θ \\ sin θ & cos θ & - h cos θ + h \\ 0 & 0 & 1\end{matrix} ) = ( \begin{matrix}1 & 0 & h sin θ \\ 0 & 1 & - h cos θ + h \\ 0 & 0 & 1\end{matrix} ) ( \begin{matrix}cos θ & - sin θ & 0 \\ sin θ & cos θ & 0 \\ 0 & 0 & 1\end{matrix} ) \qquad ( 6 )$$

That is, the motion vector decided by the movement amount MT can be expressed by a combination of the motions of the rotation and translation viewed from the origin, and a negative effect caused due to the fact that the position of the rotation axis is different does not occur.

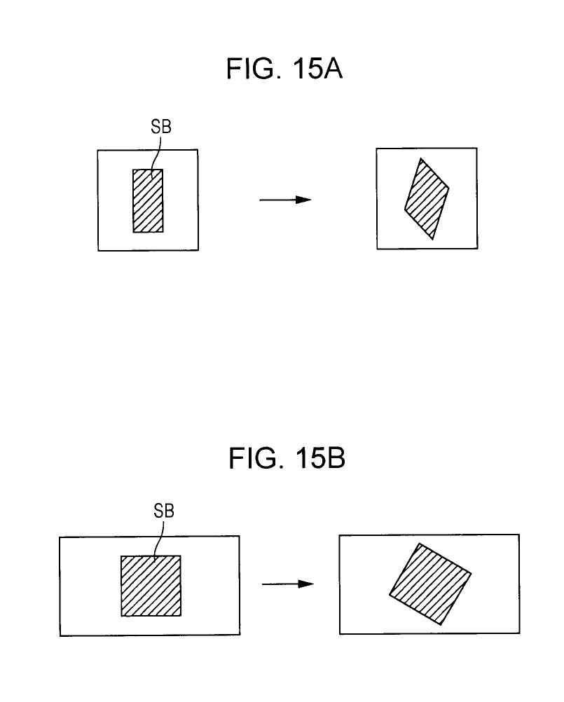

In general, the aspect ratio of each pixel in the frame image of the frame image data is not 1:1. For example, when a rectangular pixel is multiplied by the rotation element EMb, as shown in FIG. 15A, the rectangular pixel is distorted in a parallelogram shape with the rotation, as shown in the right-side drawing, due to the fact that the scale is different in the transverse direction and the longitudinal direction.

Accordingly, the motion component separation processing unit 24 first converts a pixel with no a rectangular shape into a pixel with a rectangular shape before multiplying the rotation element EMb, by multiplying a pixel correction matrix MP1 shown in Expression (7). In this expression, p denotes a pixel ratio when one side of the pixel is “1.”

$$( \begin{matrix}p & 0 & 0 \\ 0 & 1 & 0 \\ 0 & 0 & 1\end{matrix} ) \qquad ( 7 )$$

Moreover, after multiplying the rotation element EMb, the motion component separation processing unit 24 again converts the pixel converted with the rectangular shape into a pixel with a base aspect ratio by multiplying a pixel correction inverse matrix MP2 (Expression (8)) which is an inverse matrix of the pixel correction matrix MP1.

$$( \begin{matrix}\frac{1}{p} & 0 & 0 \\ 0 & 1 & 0 \\ 0 & 0 & 1\end{matrix} ) \qquad ( 8 )$$

That is, the motion component separation processing unit 24 multiplies the pixel correction matrix MP1 and the pixel correction inverse matrix MP2 before and after the rotation element EMb, as shown in Expression (9).

$$( \begin{matrix}\frac{1}{p} & 0 & 0 \\ 0 & 1 & 0 \\ 0 & 0 & 1\end{matrix} ) ( \begin{matrix}cos θ & - sin θ & 0 \\ sin θ & cos θ & 0 \\ 0 & 0 & 1\end{matrix} ) ( \begin{matrix}p & 0 & 0 \\ 0 & 1 & 0 \\ 0 & 0 & 1\end{matrix} ) \qquad ( 9 )$$

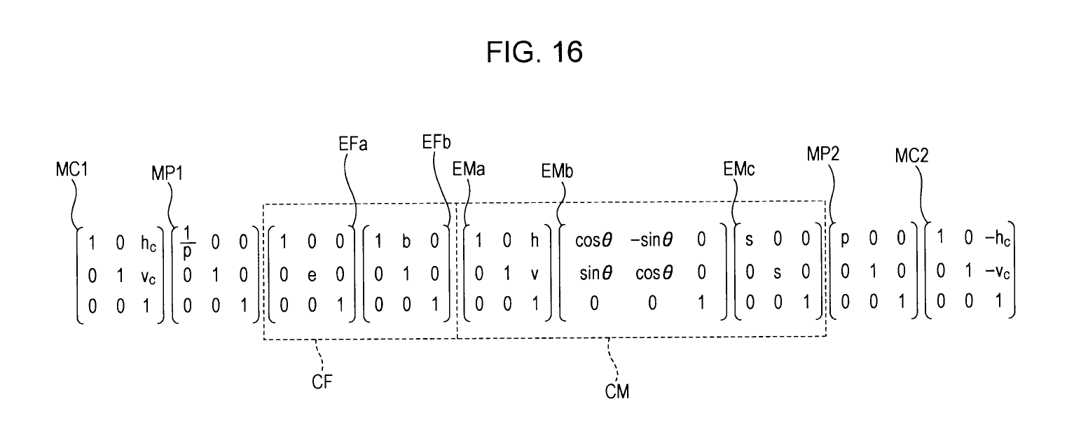

As shown in FIG. 16, the motion component separation processing unit 24 has a component separation model separating the focal plane distortion component CF and the camera motion component CM using the unknown component parameters, after correcting the origin and the aspect ratio of the pixel. Moreover, the motion component separation processing unit 24 models the global motion vector GMV by applying the global motion vector GMV to the component separation model and returns the origin and the aspect ratio of the pixel to the base aspect ratio in the final of the component separation expression.

In effect, the motion detection unit 22 of the image processing unit 13 calculates the global motion vector GMV as the affine transform determinant such as Expression (10).

$$( \begin{matrix}{x}_{1} \\ {y}_{1} \\ 1\end{matrix} ) = ( \begin{matrix}{A}_{1} & {A}_{2} & {A}_{0} \\ {B}_{1} & {B}_{2} & {B}_{0} \\ 0 & 0 & 1\end{matrix} ) ( \begin{matrix}{x}_{0} \\ {y}_{0} \\ 1\end{matrix} ) \qquad ( 10 )$$

The motion component separation processing unit 24 generates the component separation expression shown in Expression (11) by applying the global motion vector GMV to the component separation model shown in FIG. 16, when the global motion vector GMV is supplied from the motion detection unit 22.

$$( \begin{matrix}{x}_{1} \\ {y}_{1} \\ 1\end{matrix} ) = ( \begin{matrix}{A}_{1} & {A}_{2} & {A}_{0} \\ {B}_{1} & {B}_{2} & {B}_{0} \\ 0 & 0 & 1\end{matrix} ) ( \begin{matrix}{x}_{0} \\ {y}_{0} \\ 1\end{matrix} ) = ( \begin{matrix}1 & 0 & {h}_{c} \\ 0 & 1 & {v}_{c} \\ 0 & 0 & 1\end{matrix} ) ( \begin{matrix}\frac{1}{p} & 0 & 0 \\ 0 & 1 & 0 \\ 0 & 0 & 1\end{matrix} ) ( \begin{matrix}1 & 0 & 0 \\ 0 & e & 0 \\ 0 & 0 & 1\end{matrix} ) ( \begin{matrix}1 & b & 0 \\ 0 & 1 & 0 \\ 0 & 0 & 1\end{matrix} ) ( \begin{matrix}1 & 0 & h \\ 0 & 1 & v \\ 0 & 0 & 1\end{matrix} ) ( \begin{matrix}cos θ & - sin θ & 0 \\ sin θ & cos θ & 0 \\ 0 & 0 & 1\end{matrix} ) ( \begin{matrix}s & 0 & 0 \\ 0 & s & 0 \\ 0 & 0 & 1\end{matrix} ) ( \begin{matrix}p & 0 & 0 \\ 0 & 1 & 0 \\ 0 & 0 & 1\end{matrix} ) ( \begin{matrix}1 & 0 & - {h}_{c} \\ 0 & 1 & - {v}_{c} \\ 0 & 0 & 1\end{matrix} ) ( \begin{matrix}{x}_{0} \\ {y}_{0} \\ 1\end{matrix} ) \qquad ( 11 )$$

The motion component separation processing unit 24 converts Expression (11) into Expression (12).

$$( \begin{matrix}{x}_{1} \\ {y}_{1} \\ 1\end{matrix} ) = {( \begin{matrix}\frac{1}{p} & 0 & 0 \\ 0 & 1 & 0 \\ 0 & 0 & 1\end{matrix} )}^{- 1} {( \begin{matrix}1 & 0 & {h}_{c} \\ 0 & 1 & {v}_{c} \\ 0 & 0 & 1\end{matrix} )}^{- 1} ( \begin{matrix}{A}_{1} & {A}_{2} & {A}_{0} \\ {B}_{1} & {B}_{2} & {B}_{0} \\ 0 & 0 & 1\end{matrix} ) {( \begin{matrix}1 & 0 & - {h}_{c} \\ 0 & 1 & - {v}_{c} \\ 0 & 0 & 1\end{matrix} )}^{- 1} {( \begin{matrix}p & 0 & 0 \\ 0 & 1 & 0 \\ 0 & 0 & 1\end{matrix} )}^{- 1} ( \begin{matrix}{x}_{0} \\ {y}_{0} \\ 1\end{matrix} ) = ( \begin{matrix}{a}_{1} & {a}_{2} & {a}_{0} \\ {b}_{1} & {b}_{2} & {b}_{0} \\ 0 & 0 & 1\end{matrix} ) ( \begin{matrix}{x}_{0} \\ {y}_{0} \\ 1\end{matrix} ) = ( \begin{matrix}1 & 0 & 0 \\ 0 & e & 0 \\ 0 & 0 & 1\end{matrix} ) ( \begin{matrix}1 & b & 0 \\ 0 & 1 & 0 \\ 0 & 0 & 1\end{matrix} ) ( \begin{matrix}1 & 0 & h \\ 0 & 1 & v \\ 0 & 0 & 1\end{matrix} ) ( \begin{matrix}cos θ & - sin θ & 0 \\ sin θ & cos θ & 0 \\ 0 & 0 & 1\end{matrix} ) ( \begin{matrix}s & 0 & 0 \\ 0 & s & 0 \\ 0 & 0 & 1\end{matrix} ) ( \begin{matrix}{x}_{0} \\ {y}_{0} \\ 1\end{matrix} ) \qquad ( 12 )$$

The followings can be obtained when the respective component parameters (sin θ, e, b, s, h, and v) in Expression (12) are solved by a general equation.

$$\begin{matrix}In case of θ = 0 ( {b}_{1} = 0 ) \\ sin θ = 0 \\ s = - {a}_{2} s = {a}_{1} \\ b = \frac{{a}_{2}}{s} = \frac{{a}_{2}}{{a}_{1}} \\ e = \frac{{b}_{2}}{s} = \frac{{b}_{2}}{{a}_{1}} \\ v = \frac{{b}_{0}}{s} = \frac{{a}_{1} {b}_{0}}{{b}_{2}} \\ h = {a}_{0} - bv = {a}_{0} - \frac{{a}_{2} {b}_{0}}{{b}_{2}} & ( 13 ) \\ In case of θ = \frac{π}{2} ( {b}_{2} = 0 , {b}_{1} > 0 ) \\ sin θ = 1 \\ s = - {a}_{2} \\ b = \frac{{a}_{1}}{s} = - \frac{{a}_{1}}{{a}_{2}} \\ e = \frac{{b}_{1}}{sp} = - \frac{{b}_{1}}{{a}_{2}} \\ v = \frac{{b}_{0}}{e} = \frac{{a}_{2} {b}_{0}}{{b}_{1}} \\ h = {a}_{0} - bv = {a}_{0} - \frac{{a}_{1}}{{b}_{1}} & ( 14 ) \\ In case of θ = - \frac{π}{2} ( {b}_{2} = 0 , {b}_{1} < 0 ) \\ sin θ = 1 \\ s = {a}_{2} \\ b = - \frac{{a}_{1}}{s} = - \frac{{a}_{1}}{{a}_{2}} \\ e = - \frac{{b}_{1}}{s} = - \frac{{b}_{1}}{{a}_{2}} \\ v = \frac{{b}_{0}}{e} = - \frac{{a}_{2} {b}_{0}}{{b}_{1}} \\ h = {a}_{0} - bv = {a}_{0} - \frac{{a}_{1}}{{b}_{1}} & ( 15 ) \\ In the other cases of ( - \frac{π}{2} < θ < \frac{π}{2} ) \\ tan θ = \frac{{b}_{1}}{{b}_{2} p} \\ When {b}_{1} > 0 , tan θ > 0 or {b}_{1} < 0 , tan θ < 0 \\ sin θ = \frac{tan θ}{\sqrt{1 + {tan}^{2} θ}} , cos θ = \frac{1}{\sqrt{1 + {tan}^{2} θ}} \\ When {b}_{1} < 0 , tan θ > 0 or {b}_{1} > 0 , tan θ < 0 \\ sin θ = \frac{- tan θ}{\sqrt{1 + {tan}^{2} θ}} , cos θ = \frac{1}{\sqrt{1 + {tan}^{2} θ}} \\ b = \frac{{a}_{1} sin θ + {a}_{2} cos θ}{{a}_{1} cos θ - {a}_{2} sin θ} \\ s = \frac{{a}_{1}}{cos θ + b sin θ} \\ e = \frac{{b}_{1}}{sin θ} \\ v = \frac{{b}_{0}}{e} \\ h = {a}_{0} - bv & ( 16 )\end{matrix}$$

Thus, the motion component separation processing unit 24 models the global motion vector GMV expressed as the affine transform matrix by substituting the global motion vector GMV by the component separation expression separating the global motion vector GMV into the focal plane distortion component CF and the camera motion component CM using the unknown component parameters. Moreover, the motion component separation processing unit 24 calculates the respective component parameters by solving the equation to separate the global motion vector GMV into the focal plane distortion component CF and the camera motion component CM.

Moreover, the motion component separation processing unit 24 may supply only the component parameters as the focal plane distortion component CF and the camera motion component CM to the component distortion component storage buffer 25 or may supply all of the values of the matrix. The same is applied to the other processes.

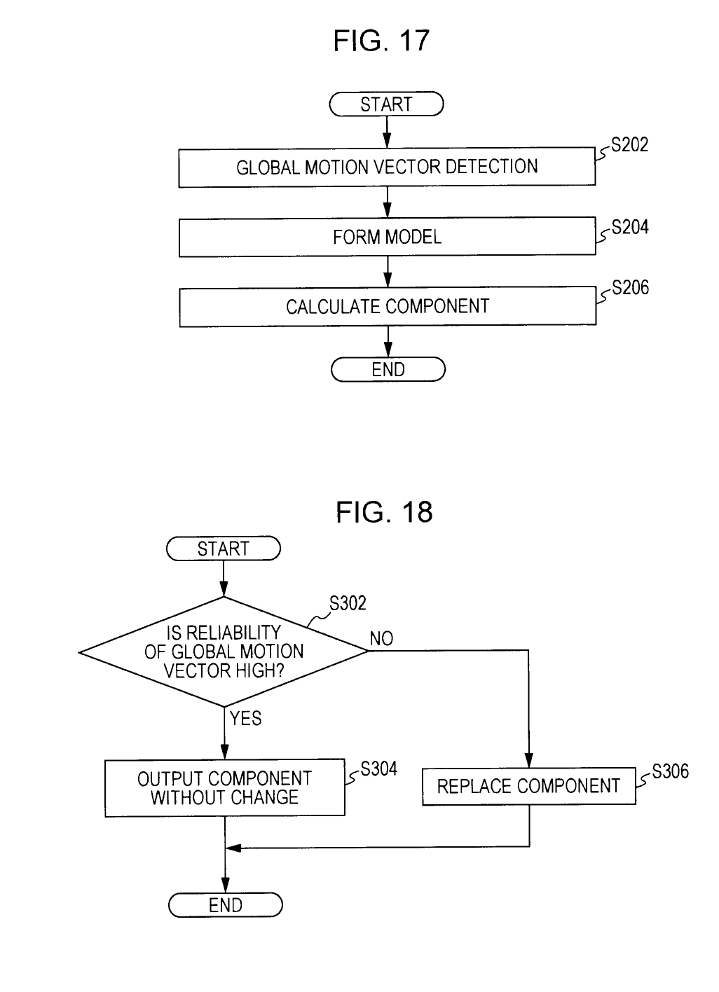

Next, the component calculation process executed according to the image processing program will be described with reference to the flowchart of FIG. 17. This component calculation process corresponds to the above-described motion detection process and the above-described motion component separation process.

The motion detection unit 22 of the image processing unit 13 starts the component calculation process when the frame image data is supplied. Then, the process proceeds to step S202.

In step S202, when the motion detection unit 22 detects the global motion vector GMV indicating the overall motion of the frame image, the motion detection unit 22 supplies the global motion vector GMV to the motion component separation processing unit 24. Then, the process proceeds to step S204.

In step S204, the motion component separation processing unit 24 of the image processing unit 13 substitutes the global motion vector GMV supplied from the motion detection unit 22 by the component separation expression shown in Expression (11) and models the global motion vector GMV by determining the center coordinates of the video (video data) based on the focus information supplied from the matching processing unit 23. Then, the process proceeds to step S206.

In step S206, the motion component separation processing unit 24 calculates the camera motion component CM and the focal plane distortion component CF by calculating the unknown component parameters of the component separation expression. Then, the process proceeds to the end step to end the component calculation process.

### 1-5. Filtering Process

The filtering processing unit 26 filters the camera motion component CM and the focal plane distortion component CF based on the reliability information generated by the motion detection unit 22.

As described above, the reliability information includes the reliability index of each local motion vector LMV in the frame image data. The filtering processing unit 26 determines whether each reliability index is equal to or greater than a predetermined high-reliability threshold value and calculates a ratio of the reliability indexes with a value equal to or greater than the high reliability threshold value for the total number of reliability indexes of each frame image data.

When the ratio of the reliability indexes with the value equal to or greater than the high-reliability threshold value is higher than the predetermined filtering threshold value, the reliability of the global motion vector GMV is high. Therefore, the filtering processing unit 26 uses the camera motion component CM and the focal plane distortion component CF of the corresponding global motion vector GMV.

When the ratio of the reliability indexes with the value equal to or greater than the high-reliability threshold value is lower than the predetermined filtering threshold value, the reliability of the global motion vector GMV is low. Therefore, the filtering processing unit 26 does not use the camera motion component CM and the focal plane distortion component CF of the corresponding global motion vector GMV.

That is, the filtering processing unit 26 supplies the camera motion component CM to the digital filter processing unit 27 and the trapezoid distortion estimation unit 28, when the reliability of the global motion vector GMV is high.

On the other hand, the filtering processing unit 26 destroys the camera motion component CM and the focal plane distortion component CF, when the reliability of the global motion vector GMV is low.

At this time, the filtering processing unit 26 considers that a predetermined unit matrix is the focal plane distortion component CF and supplies the predetermined unit matrix as the camera motion component CM to the digital filter processing unit 27 and the trapezoid distortion estimation unit 28. Moreover, the filtering processing unit 26 sets, for example, a plurality of filtering threshold values according to the reliability and replaces one of the camera motion component CM and the focal plane distortion component CF or each element by the unit matrix.

Thus, the filtering processing unit 26 selects and uses only the focal plane distortion component CF and the camera motion component CM generated based on the global motion vector GMV with high reliability.

Thus, the image processing unit 13 is configured to supply only the global motion vector GM with high reliability and less error to the digital filter processing unit 27 and the trapezoid distortion estimation unit 28.

Next, the filtering process executed according to the image processing program will be described with reference to the flowchart of FIG. 18.

The filtering processing unit 26 of the image processing unit 13 starts the filtering process when the reliability information, the camera motion component CM, and the focal plane distortion component CF are supplied from the motion component distortion component storage buffer 25. Then, the process proceeds to step S302.

In step S302, the filtering processing unit 26 determines whether the reliability of the global motion vector GMV is high based on the reliability information. When the positive result is obtained, it is indicated that the camera motion component CM and the focal plane distortion component CF are reliable. At this time, the filtering processing unit 26 allows the process to proceed to step S304.

In step S304, when the filtering processing unit 26 outputs the camera motion component CM and the focal plane distortion component CF separated by the motion component separation processing unit 24, the process proceeds to the end step to end the filter process.

On the other hand, when the negative result is obtained in step S302, it is indicated that the camera motion component CM and the focal plane distortion component CF are unreliable. At this time, the filtering processing unit 26 allows the process to proceed to step S306.

In step S306, the filtering processing unit 26 destroys the camera motion component CM the focal plane distortion component CF to displace them by the unit matrix and outputs the unit matrix as the camera motion component CM and the focal plane distortion component CF. Then, the filter processing unit 26 allows the process to proceed to the end step to end the filtering process.

The filtering processing unit 26 performs the FP distortion correction amount calculation process.

The focal plane distortion does not occur independently in the frame image, but occurs when distortion continuously occurs between the plurality of frame images and accumulates. However, the global motion vector GMV indicates a motion for the immediately previous frame image. That is, the focal plane distortion component CF indicates a variation amount increased or decreased with respect to the previous frame image.

Accordingly, in order to exactly correct the focal plane distortion, it is preferable to correct the accumulative value of the focal plane distortion component CF.

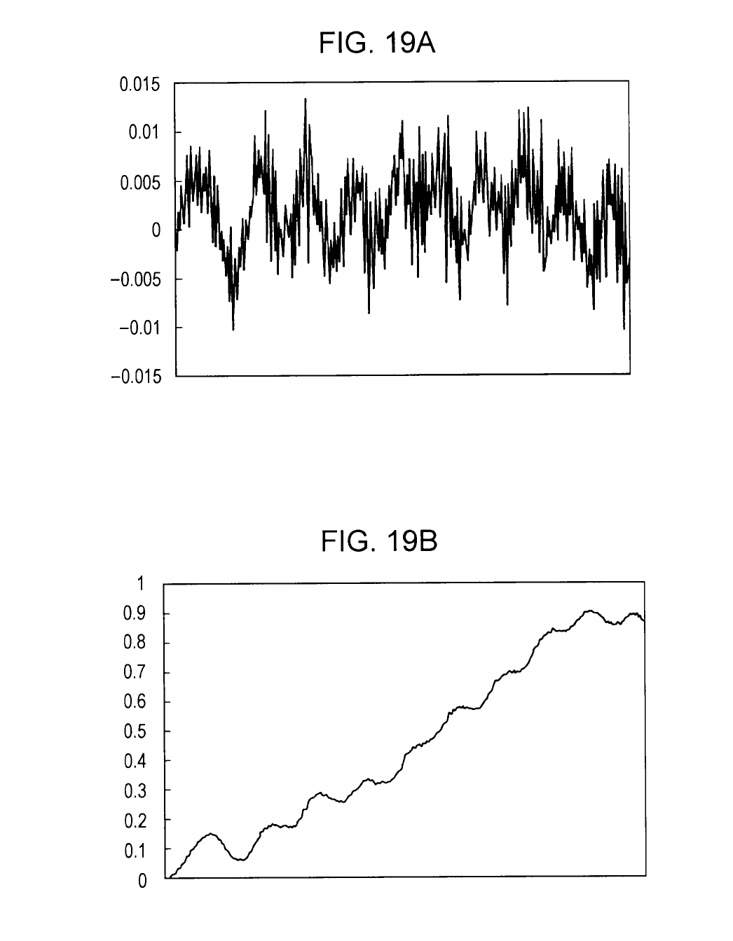

However, the focal plane distortion component CF has an error. FIG. 19A is a diagram illustrating the focal plane distortion component CF when the focal plane distortion slightly occurs due to, for example, camera shaking. When the focal plane distortion component CF has a positive sign, the focal plane distortion increases. When the focal plane distortion component CF has a negative sign, the focal plane distortion decreases.

FIG. 19B is a diagram illustrating an FP distortion accumulative value which is an accumulative value of the focal plane distortion component CF (see FIG. 19A). As understood from FIG. 19B, the FP distortion accumulative value considerably increases as the number of frame images increases. This is the result that is obtained when the error of the focal plane distortion component CF accumulates and spreads. That is, when the frame image is corrected using the accumulative value of the focal plane distortion component CF, there is a possibility that the frame image may be broken down due to the accumulation of the error.

Accordingly, the filtering processing unit 26 of the image processing unit 13 calculates the FP distortion correction amount CFc so that the FP distortion correction amount CFc is the same as the focal plane distortion of the frame image that has the smallest focal plane distortion among the frame image to be processed and the frame images before and after this frame image to be processed.

Here, the camera motion component CM has a smaller error and a higher reliability than the focal plane distortion component CF does. The focal plane distortion component CF has a correlation with the translation speed of the camera motion component CM. Here, the filtering processing unit 26 calculates the FP distortion correction amount CFc based on the translation speed.

The FP distortion correction amount CFc is expressed as a matrix in which the FP distortion component parameter e is replaced by e_{c} and the FP distortion component parameter b is replaced by b_{c} in the focal plane distortion component CF of Expression (1). In the correction vector generation processed described below, the focal plane distortion in the frame image to be processed is corrected by being multiplied by the inverse matrix of the FP distortion correction amount CFc.

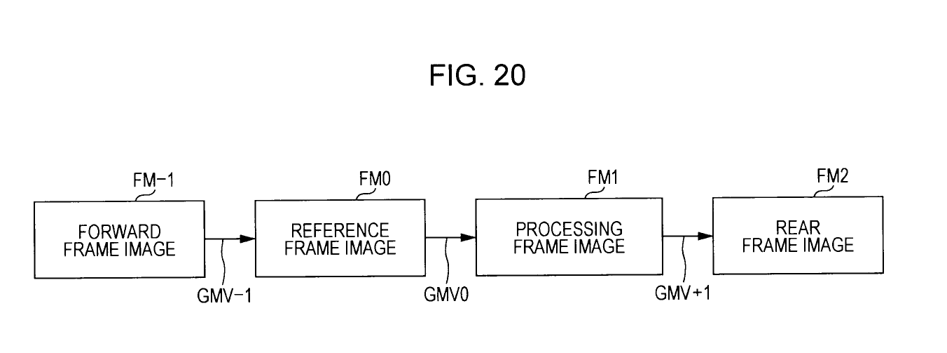

As shown in FIG. 20, an immediately previous frame image of a frame image FM1 to be processed is referred to as a reference frame image FM0 and an immediately previous of the reference frame image FM0 is referred to as a front frame image FM−1. An immediately subsequent frame image of the frame image FM1 to be processed is referred to as a subsequent frame image FM2.

The motion of the frame image FM1 to be processed when the reference frame image FM0 is used as a reference is referred to as a global motion vector GMV0. The motion of the reference frame image FM0 when the front frame image FM−1 is used a reference is referred to as a global motion vector GMV−1. The motion of the subsequent frame image FM2 when the frame image FM1 to be processed is used as a reference is referred to as a global motion vector GMV+1. These global motion vectors are collectively referred to as simply a global motion vector GMV.

The camera motion component CM and the focal plane distortion component CF corresponding to the global motion vector GMV are sequentially supplied to the filtering processing unit 26. The camera motion components CM corresponding to the global motion vectors GMV0, GMV+1, and GMV−1 are referred to as camera motion components CM0, CM+1, and CM−1, respectively. The focal plane distortion components CF corresponding to the global motion vectors GMV0, GMV+1, and GMV−1 are referred to as focal plane distortion components CF0, CF+1, and CF−1, respectively.

The filtering processing unit 26 compares the values of the motion component parameters v in the camera motion components CM0, CM+1, and CM−1 to each other. The motion component parameter v indicates the translation speed in the longitudinal direction. When the translation speed in the longitudinal direction is large, the focal plane distortion becomes large. When the translation speed in the longitudinal direction is small, the focal plane distortion becomes small.

The filtering processing unit 26 selects the camera motion component CM with the smallest the translation speed (that is, the value of the motion component parameter v) in the longitudinal direction among the camera motion components CM0, CM+1, and CM−1.

When the selected camera motion component CM is the camera motion component CM0, the filtering processing unit 26 sets the focal plane distortion to be the same as that of the frame image FM1 to be processed. The filer processing unit 26 sets the unit matrix to the FP distortion correction amount CFc and sets the FP distortion component parameter e_{c} indicating the zoom of the FP distortion correction amount Cfc in the longitudinal direction to “1.” As a consequence, the focal plane distortion is not corrected for the zoom in the longitudinal direction.

On the other hand, when the selected camera motion component CM is the camera motion component CM−1, the filtering processing unit 26 sets the focal plane distortion to be the same as that of the reference frame image FM0 to be processed. The filtering processing unit 26 sets the focal plane distortion component CF0 to the FP distortion correction amount CFc and sets the FP distortion component parameter e_{c} to “e” in the focal plane distortion component CF0. As a consequence, the focal plane distortion is corrected to the same level as that of the reference frame image FM0 for the zoom in the longitudinal direction.

On the other hand, when the selected camera motion component CM is the camera motion component CM+1, the filtering processing unit 26 sets the focal plane distortion to be the same as that of the subsequent frame image FM2. The filtering processing unit 26 sets the inverse matrix of the focal plane distortion component CF+1 to the FP distortion correction amount CFc and sets the FP distortion component parameter e_{c} to an “inverse number of e” in the focal plane distortion component CF+1. As a consequence, the focal plane distortion is corrected to the same level as that of the subsequent frame image FM2 for the zoom in the longitudinal direction.

Likewise, the filtering processing unit 26 compares the values of the motion component parameters h in the camera motion components CM0, CM+1, and CM−1 to each other and selects the camera motion component CM with the smallest translation speed (that is, the value of the motion component parameter h) in the transverse direction.

The filtering processing unit 26 selects the FP distortion component parameter B_{c} from “0”, “b” of the focal plane distortion component CF0, and the “inverse number of b” of the focal plane distortion component CF+1 according to the selected camera motion component CM0, CM−1, and CM+1.

The filtering processing unit 26 set the selected FP distortion component parameters e_{c} and b_{c} to the FP distortion correction amount CFc and supplies the FP distortion correction amount CFc to the correction vector generation unit 29.

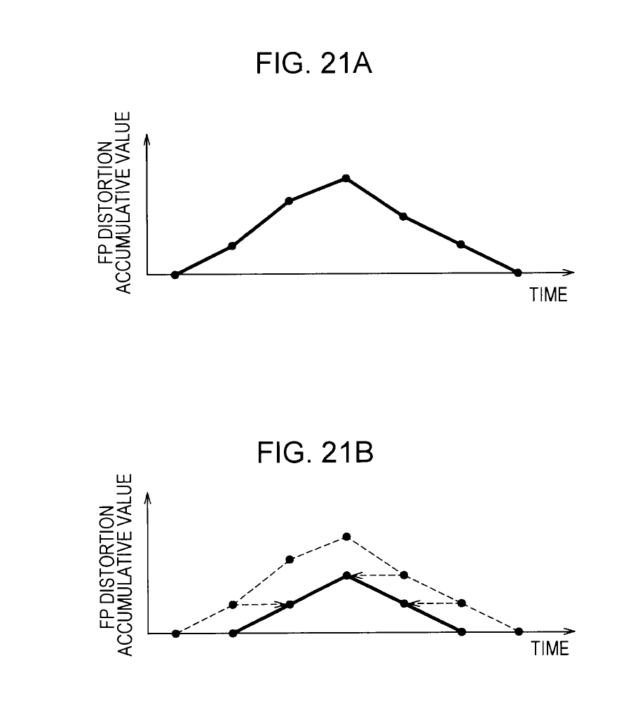

Thus, the filtering processing unit 26 does not spread the FP distortion correction amount CFc, since the focal plane distortion component CF is not accumulated. Moreover, as shown in FIG. 21B, the filtering processing unit 26 may not correct all of the focal plane distortions (FIG. 21A). However, since the filtering processing unit 26 can make the focal plane distortion smaller than the FP distortion accumulative value, the focal plane distortion can be reduced.

The focal plane distortion increases or decreases at the short interval of about five frames, for example, the positive and negative signs are replaced, and thus it is confirmed that the maximum amount of the focal plane distortion does not increase so much. Accordingly, the filtering processing unit 26 can allow the focal plane distortion not to be noticed visually in the frame image just by reducing the maximum amount of the focal plane distortion.

In this way, the filtering processing unit 26 selects the frame image FM with the smallest focal plane distortion based on the translation speed among the frame image FM1 to be processed, the reference frame image FM0, and the subsequent frame image FM2. The filtering processing unit 26 calculates the FP distortion correction amount CFc so as to have the same level as that of the selected frame image FM.

Thus, the filtering processing unit 26 can reliably prevent the FP distortion correction amount CFc from spreading and can reduce the focal plane distortion so that the focal plane distortion is rarely noticed visually.

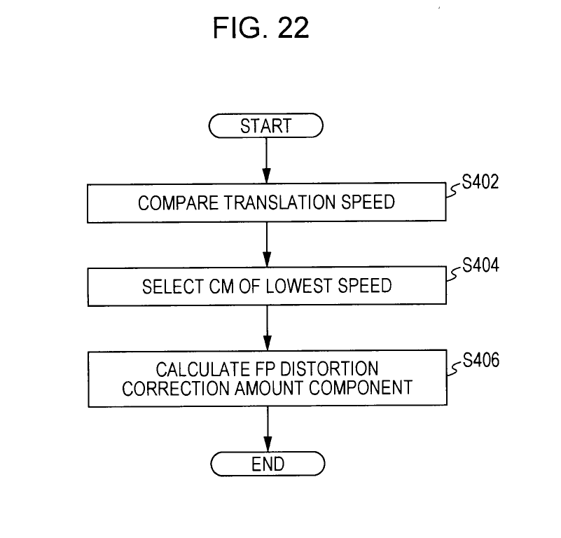

Next, the FP distortion correction amount calculation process executed according to the image processing program will be described with reference to the flowchart of FIG. 22.

The filtering processing unit 26 starts the FP distortion correction amount calculation process, when the global motion vector GMV is supplied. Then, the process proceeds to step S402.

In step S402, the filtering processing unit 26 compares the values of the motion component parameters h and v of the camera motion components CM0, CM+1, and CM−1 to each other, and then the process proceeds to step S404.

In step S404, the filtering processing unit 26 selects the camera motion component CM with the slowest translation speed (that is, the values of the motion component parameters h and v), and then process proceeds to step 406.

In step S406, the filtering processing unit 26 calculates the FP distortion correction amount CFc according to the camera motion component CM selected in step S406. At this time, the filtering processing unit 26 calculates the FP distortion correction amount CFc so that the focal plane distortion has the same level as that of the frame image corresponding to the camera motion component CM.

Then, the filtering processing unit 26 allows the process to proceed to the end step to end the FP distortion correction amount calculation process.

### 1-6. Calculation of Camera Work Amount

The digital filter processing unit 27 calculates the camera work amount which is the user's intended motion by applying the predetermined number LPF of taps to the motion component parameters θ, s, h, and v supplied from the filtering processing unit 26.

Specifically, the component parameters corresponding to the number of taps are acquired and the motion component parameters (hereinafter, referred to as “camera work component parameters”) after the filter are acquired by applying the component parameters to an FIR (Finite Impulse Response Filter). The camera work component parameter indicates the camera work amount. Hereinafter, the camera work component parameters are denoted by θ_{f}, s_{f}, h_{f}, and v_{f}.

The number of taps in the LPF is set so that the characteristic of the LPF is sufficiently reflected. In the LPF, a cutoff frequency is set so as to reliably cut the vicinity of the frequency considered to be camera shaking. Moreover, a simple movement average filter may be used.

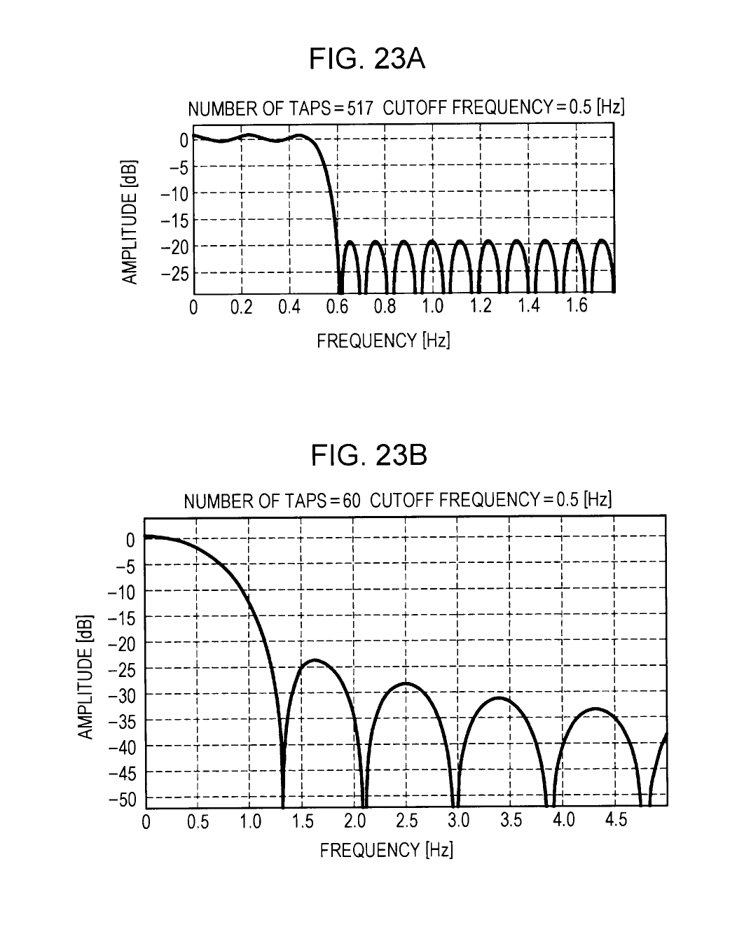

When the cutoff frequency is set to 0.5 [Hz], as shown in FIG. 23A, the accuracy in the LPF can be made to be high by setting the number of taps to about 517. Even when the number of taps is lowered to about 60, as shown in FIG. 23B, the accuracy is lowered. However, the performance of the LPF can be achieved to some extent.

Accordingly, it is preferable that the digital filter processing unit 27 is set based on the mounting constraint such as the hardware processing performance, the output delay allowable range, or the like of the image processing unit 13.

Thus, the digital filter processing unit 27 is configured to generate the camera work component parameters θ_{f}, S_{f}, h_{f}, and v_{f} indicating the camera work amount by performing the LPF processing on the motion component parameters θ, s, h, and v indicating the camera motion amount.

### 1-7. Removal of Trapezoid Distortion

As described above, the function of correcting the camera shaking of the camcorder 1 enables the angle variation between a subject and the lens unit 3 in the yaw direction and the pitch direction to be suppressed. However, the camcorder 1 does not completely cancel the angle variation and also cancels the camera shaking in the vertical direction and the horizontal direction by the driving of the lens unit 3 in the yaw direction and the pitch direction.

Therefore, the frame image data has the variation in the angle in the yaw direction and the pitch direction. The angle variation is shown as the trapezoid distortion for the frame image.

Here, the image processing unit 13 according to this embodiment estimates the variation in the angle in the yaw direction and the pitch direction from the translation speed in the global motion vector GMV and calculates a trapezoid distortion amount A based on the angle variation. The image processing unit 13 is configured to remove the influence of the trapezoid distortion from the frame image data by cancelling the trapezoid distortion amount A for the frame image to be processed.

### 1-8. Trapezoid Distortion Estimation Process

As shown in Expression (11), the component separation expression does have the components in the yaw direction and the pitch direction. Therefore, the angle variation of the yaw direction and the pitch direction is shown as the translation speed (that is, the motion component parameters h and v) in the transverse direction and the longitudinal direction. Accordingly, the translation speed and the angle variation of the yaw direction and the pitch direction have a correlation.

Here, the trapezoid distortion estimation unit 28 of the image processing unit 13 estimates the angle variation of the yaw direction and the pitch direction based on the motion component parameters h and v and performs a trapezoid distortion estimation process to calculate the trapezoid distortion amount caused due to the angle variation.

Here, the trapezoid distortion amount A caused due to only the yaw direction and the pitch direction can be modeled into Expression (17) by using angle parameters ω and φ and the projection transform expression shown in Expression (2). In Expression (17), −cos ω sin φ corresponding to c1 in Expression (2) represents the angle variation of the yaw direction and sin φ corresponding c2 represents the angle variation of the pitch direction.

$$A = \frac{1}{\begin{matrix}( - cos ω sin ϕ ) x + \\ y sin ω + cos ω cos ϕ\end{matrix}} ( \begin{matrix}cos ϕ & 0 & sin ϕ \\ sin ω sin ϕ & cos ω & - sin ω cos ϕ \\ - cos ω sin ϕ & sin ω & cos ω cos ϕ\end{matrix} ) \qquad ( 17 )$$

Here, the trapezoid distortion is the phenomenon that occurs due to not only the camera shaking but also the camera work. The trapezoid distortion that has to be corrected is the trapezoid distortion amount A caused due to the camera shaking. Here, the trapezoid distortion estimation unit 28 estimates the angle variation caused due to the camera shaking from the translation speed (hereinafter, referred to as “camera shaking translation speed”) occurring due to the camera shaking.

The trapezoid distortion estimation unit 28 calculates camera shaking translation speeds h−h_{f} and v−v_{f} among the translation speeds in the transverse direction and the longitudinal direction. The trapezoid distortion estimation unit 28 estimates the angle variations yaw and pitch caused due to the camera shaking by Expression (18) by multiplying the camera shaking translation speeds h−h_{f} and v−v_{f} by designated coefficient m and n and fixed coefficient p and q.

yaw=m(h−h_{f})×p,pitch=n(v−v_{f})×q (18)

In this expression, the designated coefficients m and n are parameters designated from the outside and are set to “1” as an initial value in the trapezoid distortion estimation process. The fixed coefficients p and q are coefficients calculated statistically or theoretically based on the correlation between the angle variation caused due to the camera shaking and the camera shaking translation speed.

The trapezoid distortion estimation unit 28 calculates the angle parameters ω and φ by Expression (19) by using the values obtained by Expression (18).

$$- cos ω sin ϕ = yaw , sin ω = pitch ( - \frac{π}{2} \leq ω \leq \frac{π}{2} , - \frac{π}{2} \leq ϕ \leq \frac{π}{2} ) \qquad ( 19 )$$

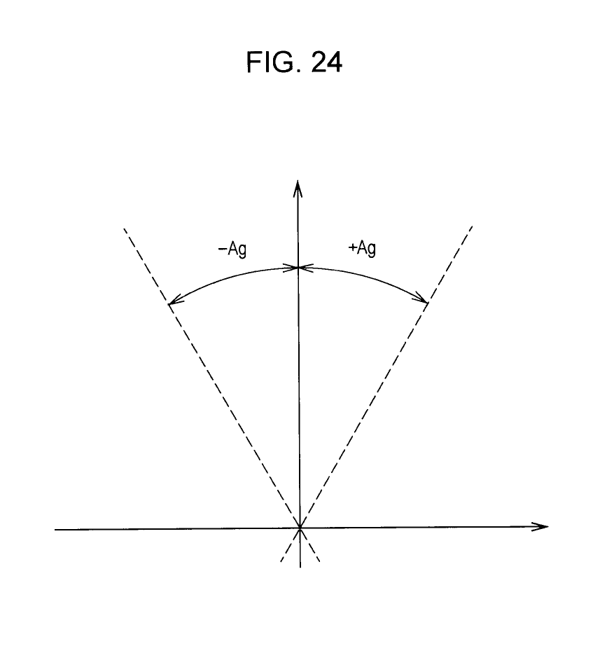

However, when the angle parameters ω and φ are erroneous, the frame image is broken down. Therefore, as shown in FIG. 24, the trapezoid distortion estimation unit 28 determines whether the values of the angle parameters ω and φ are within an appropriate angle range (−Ag° to +Ag°).

The trapezoid distortion estimation unit 28 uses the angle parameters ω and φ without change, when the values of the angle parameters ω and φ are within the appropriate angle range. On the other hand, the trapezoid distortion estimation unit 28 considers the values of the angle parameters ω and φ as “0”, when the values of the angle parameters ω and φ are not within the appropriate angle range.

The trapezoid distortion estimation unit 28 calculates the trapezoid distortion amount A as a matrix by substituting the calculated angle parameters ω and φ to Expression (17). The trapezoid distortion estimation unit 28 supplies the trapezoid distortion amount A to the correction vector generation unit 29.

In this way, the trapezoid distortion estimation unit 28 is configured to estimate the trapezoid distortion amount A based on the motion component parameters h and v.

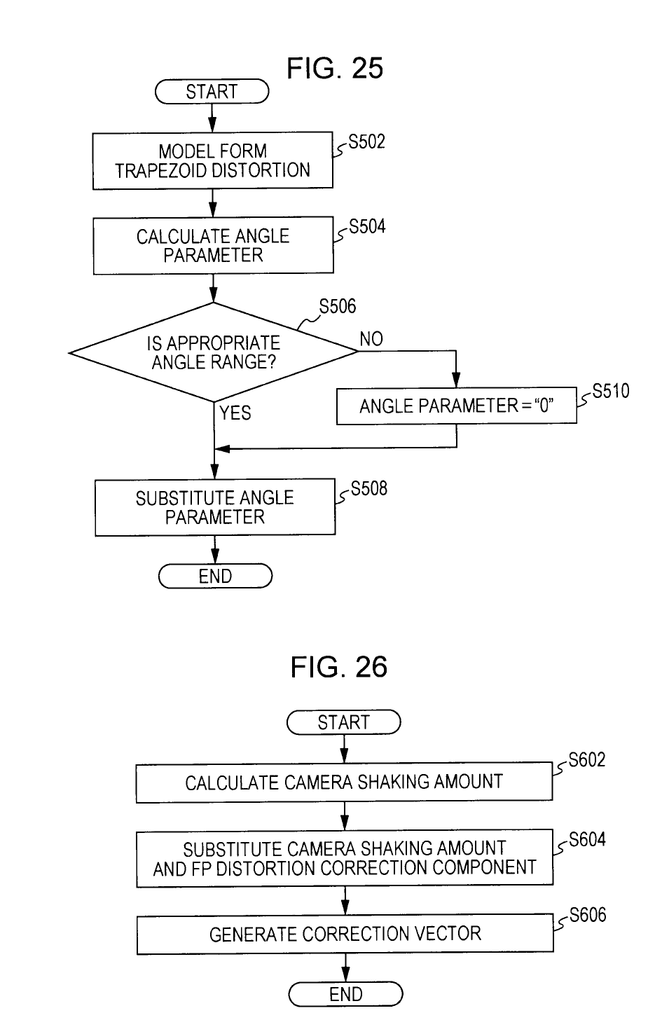

Next, the trapezoid distortion estimation process executed according to the image processing program will be described with reference to the flowchart of FIG. 25.

The trapezoid distortion estimation unit 28 starts the trapezoid distortion estimation process when the motion component parameters v and h are supplied, and then the process proceeds to step S502.

In step S502, the trapezoid distortion estimation unit 28 models the trapezoid distortion amount A into Expression (17) by the projection transform, and then the process proceeds to step S504.

In step S504, the trapezoid distortion estimation unit 28 calculates the angle parameters ω and φ, and then the process proceeds to step S506.

In step S506, the trapezoid distortion estimation unit 28 determines whether the angle parameters ω and φ are within the appropriate angle range. When the positive result is obtained, the trapezoid distortion estimation unit 28 allows the process to proceed to step S508.

On the other hand, when the negative result is obtained in step S506, there is a high possibility that the angle parameters ω and φ are erroneous. Therefore, the trapezoid distortion estimation unit 28 allows the process to proceed to step S510.

In step S510, the trapezoid distortion estimation unit 28 replaces the angle parameters ω and φ by “0”, and then the process proceeds to step S508.

When the trapezoid distortion estimation unit 28 substitutes the values of the angle parameters ω and φ to Expression (17) in step S508, the process proceeds to the end step to end the trapezoid distortion estimation process.

### 1-9. Generation of Correction Vector

In order to correct the camera shaking focal plane distortion and the trapezoid distortion, the correction vector generation unit 29 generates the correction vector Vc applied to the frame image to be processed.

For convenience sake, a component separation expression such as Expression (21) shown in Expression (11) can be obtained when the respective components and matrixes are expressed as Expression (20). Moreover, a coordinate X₀ before transform is a coordinate corresponding to the reference frame image FM0 and a coordinate X₁ after transform is a coordinate corresponding to the frame image FM1 to be processed.

$$\begin{matrix}{X}_{0} ( coordinate before transform ) = ( \begin{matrix}{x}_{0} \\ {y}_{0} \\ 1\end{matrix} ) \\ {X}_{1} ( coordinate after transform ) = ( \begin{matrix}{x}_{0} \\ {y}_{0} \\ 1\end{matrix} ) \\ F ( FP distortion correction amount CFc ) = ( \begin{matrix}1 & 0 & 0 \\ 0 & {e}_{c} & 0 \\ 0 & 0 & 1\end{matrix} ) ( \begin{matrix}1 & {b}_{c} & 0 \\ 0 & 1 & 0 \\ 0 & 0 & 1\end{matrix} ) \\ M ( camera motion component CM ) = ( \begin{matrix}1 & 0 & h \\ 0 & 1 & v \\ 0 & 0 & 1\end{matrix} ) ( \begin{matrix}cos θ & - sin θ & 0 \\ sin θ & cos θ & 0 \\ 0 & 0 & 1\end{matrix} ) ( \begin{matrix}s & 0 & 0 \\ 0 & s & 0 \\ 0 & 0 & 1\end{matrix} ) \\ P ( aspect ratio correction matrix MP 1 ) = ( \begin{matrix}\frac{1}{p} & 0 & 0 \\ 0 & 1 & 0 \\ 0 & 0 & 1\end{matrix} ) \\ C ( origin correction matrix MC 1 ) = ( \begin{matrix}1 & 0 & {h}_{c} \\ 0 & 1 & {v}_{c} \\ 0 & 0 & 1\end{matrix} ) \\ & ( 20 ) \\ {X}_{1} = {C}^{- 1} {P}^{- 1} {FMPCX}_{0} & ( 21 )\end{matrix}$$

Expression (22) is satisfied when the camera shaking amount is Mₛ and the camera work amount is M_{c}.

M=MₛM_{c} (22)

The camera shaking amount Mₛ can be calculated by subtracting the camera work component parameter from the motion component parameter in the camera motion component CM(M). The correction vector generation unit 29 calculates the camera shaking amount Mₛ from the motion component parameters θ, s, h, and v and the camera work component parameters θ_{f}, S_{f}, h_{f}, and v_{f} supplied from the camera work amount calculation unit 27 by Expression (23).

$${M}_{c} = ( \begin{matrix}1 & 0 & {h}_{f} \\ 0 & 1 & {v}_{f} \\ 0 & 0 & 1\end{matrix} ) ( \begin{matrix}cos {θ}_{f} & - sin {θ}_{f} & 0 \\ sin {θ}_{f} & cos {θ}_{f} & 0 \\ 0 & 0 & 1\end{matrix} ) ( \begin{matrix}{s}_{f} & 0 & 0 \\ 0 & {s}_{f} & 0 \\ 0 & 0 & 1\end{matrix} ) \\ {M}_{s} = {MM}_{c}^{- 1} \qquad ( 23 )$$

Expression (24) can be expressed by substituting Expression (22) to Expression (21) for transform.

X₁=C⁻¹P⁻¹FMₛM_{c}PCX₀=(C⁻¹P⁻¹FMₛPC)(C⁻¹P⁻¹M_{c}PC)X₁ (24)

Moreover, Expression (25) can be obtained by transforming Expression (24).

C⁻¹P⁻¹M_{c}PCX₀=C⁻¹P⁻¹Mₛ⁻¹F⁻¹PCX₁ (25)

Accordingly, as shown in Expression (25), it can be understood that the left side obtained by operating only the camera work amount M_{c} for the coordinate X₀ before transform becomes equal to the right side obtained by operating the inverse matrix of the camera shaking amount Mₛ and the focal plane distortion CF(F) for the coordinate X₁ after transform.

In other words, the coordinate obtained by operating only the reference frame image FM0 to the camera work amount M_{c} (that is, cancelling the camera shaking amount, the FP distortion correction amount CFc, and the trapezoid distortion amount A) can be acquired by multiplying the coordinate X₁ after transform by the correction vector Vc shown in Expression (26).

V_{c}=C⁻¹P⁻¹Mₛ⁻¹F⁻¹PC (26)

Accordingly, when the motion component parameters θ, s, h, and v, the camera work component parameters θ_{f}, s_{f}, h_{f}, and v_{f}, and the FP distortion component parameters e_{c} and b_{c} are supplied, the correction vector generation unit 29 generates the correction vector Vc by Expression (23) and Expression (26) and supplies the correction vector Vc to the motion compensation unit 30. Moreover, since one correction vector Vc is generated for a video (video data) of each viewpoint, the plurality of correction vectors Vc are generated in this embodiment.

As a consequence, when the motion compensation unit 30 applies the correction vector Vc for the video (video data) of each viewpoint to the video (video data) of each viewpoint, the camera shaking, the focal plane distortion, and the trapezoid distortion in the frame image FM1 to be processed are corrected.

In this way, the correction vector generation unit 29 generates the frame image FM1 to be processed to which only the camera work amount Mc is applied, compared to the reference frame image FM0, by correction of the camera shaking, the focal plane distortion, and the trapezoid distortion.

Next, the correction vector generation process executed according to the image processing program will be described with reference to the flowchart of FIG. 26.

The correction vector generation unit 29 starts the correction vector generation process, when the camera motion component CM, the camera work component CMc, the FP distortion correction amount CFc, and the trapezoid distortion amount A are supplied. Then, the process proceeds to step S602.

In step S602, the correction vector generation unit 29 calculates the camera shaking amount Mₛ by Expression (23) based on the camera motion component CM and the camera work component CMc, and then the process proceeds to step S604.

In step S604, the correction vector generation unit 29 substitutes the inverse matrix (Mₛ⁻¹) of the camera shaking amount Mₛ and the inverse matrix (F⁻¹) of the FP distortion correction amount CFc to Expression (26), and then the process proceeds to step S606.

In step S606, the correction vector generation unit 29 generates the correction vector Vc by Expression (26), and then the process proceeds to the end step to end the correction vector generation process.

The above-described series of image processing may be executed by hardware or software. When the image processing is realized by software, the image processing unit 13 is virtually formed in a CPU and a RAM. In addition, the image processing is realized by developing the image processing program stored in the ROM into the RAM.

### 1-10. Operations and Advantages

The image processing unit 13 of the image processing terminal 10 with the above-described configuration detects the global motion vector GMV which is the motion vector indicating the overall motion of the frame image from one piece of video data of at least two pieces of video data forming the processing target frame image. The image processing unit 13 models the detected global motion vector GMV into the component separation expression (Expression (11)) by using the camera motion indicating the movement of the camera and the unknown component parameters θ, s, h, v, e, and b indicating the variation amount of the focal plane distortion. As a consequence, the camera motion component CM and the focal plane distortion component CF can be separated from the component separation expression.

The image processing unit 13 calculates the camera motion component CM in the global motion vector GMV by calculating the component parameters θ, s, h, v, e, and b used in the component separation expression.

Thus, the image processing unit 13 can consider that the global motion vector GMV is formed only by the camera motion component CM and the focal plane distortion component CF. Therefore, the image processing unit 13 calculates the camera motion component CM in the global motion vector GMV by the simple and easy process.

The image processing unit 13 corrects the camera shaking of the frame image FM based on the camera motion component CM. Thus, since the image processing unit 13 can correct the camera shaking, which is shaking obtained by excluding the user's intended motion from the camera motion component CM, based on the camera motion component CM from which the focal plane distortion component CF is removed, accuracy of the correction of the camera shaking can be improved.

The image processing unit 13 expresses the camera motion component CM as the translation element EMa indicating the translation speed in the longitudinal direction and the transverse direction, the zoom element EMc indicating the zoom speed in the zoom direction, and the rotation element indicating the angle variation of one direction.

Thus, since the image processing unit 13 expresses the camera motion component CM as the affine transform expression containing the parallel movement and the angle variation of one direction, it is possible to treat with the component separation expression and calculate the component parameters simply and easily.

The image processing unit 13 expresses the global motion vector GMV as the affine transform expression including the translation element EMa, the zoom element EMc, and the rotation element EMb of one direction.

In general image processing such as image edit, the global motion vector GMV is frequently treated as the affine transform expression. Therefore, since the image processing unit 13 can treat the global motion vector GMV as the general image processing, the processing can efficiently be performed.

The image processing unit 13 calculates the camera shaking amount Mₛ indicating the amount of camera shaking by calculating the camera work component CMc indicating the user's intended motion of the camera based on the camera motion component CM and subtracting the camera work component CFc from the camera motion component CM.

The image processing unit 13 generates the correction vector Vc used to correct the camera shaking in the global motion vector GMV based on the calculated camera shaking amount Mₛ. The image processing unit 13 applies the generated correction vector Vc to the global motion vector GMV.

Thus, since the image processing unit 13 can correct only the calculated camera shaking amount Mₛ for the camera shaking in the frame image FM1 to be processed, the camera shaking in the frame image FM1 to be processed can be reduced.

The image processing unit 13 expresses the camera motion component CM and the focal plane distortion component CF as a determinant. Thus, the image processing unit 13 can easily model the camera motion component CM and the focal plane distortion component CF.

The image processing unit 13 generates the determinant including the inverse matrix Mₛ⁻¹ of the camera shaking amount Mₛ as the correction vector Vc. Thus, the image processing unit 13 can cancel the camera shaking corresponding to the camera shaking amount Mₛ from the frame image to be processed by applying the correction vector Vc to the frame image to be processed.

The image processing unit 13 calculates the FP distortion correction amount CFc as the focal plane distortion correction amount used to correct the frame image based on the calculated focal plane distortion component CF and generates the determinant including the inverse matrix F⁻¹ of the FP distortion correction amount CFc as the correction vector Vc.

Thus, the image processing unit 13 can cancel the focal plane distortion corresponding to the FP distortion correction amount CFc from the frame image to be processed by applying the correction vector Vc to the frame image to be processed.

The image processing unit 13 multiplies the origin correction matrix MC1, which moves the origin to the center of the frame image, before the rotation element EMb and multiplies the origin correction inverse matrix MC2, which returns to the position of the origin before the movement to the center, after the rotation element EMb.

Thus, the image processing unit 13 can appropriately rotate the frame image using the center of the frame image as the origin, even when the origin is the position other than the center of the frame image.

The image processing unit 13 multiplies the aspect ratio correction matrix MP1, which changes the aspect ratio of the pixel to 1:1, before the rotation element EMb, and multiplies the aspect ratio correction inverse matrix MP2, which returns the pixel to the pixel with the base aspect ratio, after the rotation element EMb.

Thus, the image processing unit 13 can treat the aspect ratio of the pixel as 1:1. Therefore, even when the aspect ratio of the pixel is not 1:1, the frame image can appropriately be rotated.

The image processing unit 13 generates the correction vector by Expression (26) on the assumption that the correction vector is Vc, the origin correction matrix is C, the aspect ratio correction matrix is P, the inverse matrix of the camera shaking amount is Mₛ⁻¹, the inverse matrix of the focal plane distortion correction amount is F⁻¹, the origin correction inverse matrix is C⁻¹, and the aspect ratio correction inverse matrix is P⁻¹.

Thus, the image processing unit 13 removes the problem with the rotation axis associated with the rotation or the aspect ratio of the pixel, and then can generate the correction vector Vc used to correct the camera shaking amount Mₛ and the FP distortion correction amount CFc.

The image processing unit 13 generates the reliability information indicating the reliability of the global motion vector GMV and calculates the camera work component CMc using only the camera motion component CM with the high reliability in the global motion vector GMV based on the generated reliability information.

Thus, it is not necessary for the image processing unit 13 to use the camera motion component CM with low reliability and large error. Therefore, the detection accuracy of the camera work component CMc can be improved.

The image processing unit 13 generates the camera work component CMc from the camera motion component CM by the LPF processing. Thus, the image processing unit 13 can generate the camera work component CMc by the simple and easy process.

In the frame image data, the rotation element EMb indicating the angle variation of one direction and the camera shaking for the rotation element indicating the angle variation of the two different directions are corrected in advance. Thus, the image processing unit 13 can calculate the camera motion component CM with high precision, since the values of two directions suppressed in the angle variation are considered to be very small.

The image processing unit 13 corrects the camera shaking for the rotation element indicating the angle variation of the yaw direction and the pitch direction in advance. Thus, the image processing unit 13 can express the angle variation of the yaw direction and the pitch direction which may not be expressed as the angle variation in the component separation expression, the error in the camera motion component CM can be reduced.

The image processing unit 13 models the focal plane distortion component CF into Expression (1) on the assumption that the component parameters are e and b. Thus, the image processing unit 13 can appropriately model the focal plane distortion shown as the distortion in the zoom of the longitudinal direction and the parallelogram shape.

The image processing unit 13 models the camera motion component CM into Expression (3) on the assumption that the component parameters are θ, h, v, and s. Thus, the image processing unit 13 can appropriately model the camera motion component CM into the rotation of the roll direction, the translation speed of the longitudinal direction and the transverse direction, and the zoom speed.

The image processing unit 13 models the motion vector into Expression (11). Thus, the image processing unit 13 can remove the problem with the rotation axis associated with the rotation or the aspect ratio of the pixel, and then can model the global motion vector GMV into the affine transform expression including only the rotation of one direction by appropriately separating the camera motion component CM and the focal plane distortion component CF.

With such a configuration, the image processing unit 13 models the global motion vector GMV into the component separation expression using the unknown component parameters on the assumption the global motion vector GMV is nearly formed by the camera motion component CM and the focal plane distortion component CF. The image processing unit 13 calculates the camera motion component CM by calculating the component parameters.

Thus, the image processing unit 13 can calculate the camera motion component CM by the simple and easy process using the simple and easy component separation expression.

In the above-described first embodiment, the matching processing unit 23 does not perform stereo matching on each frame image as a matching process. For example, the matching processing unit 23 may perform the matching process at the following timing.

For example, the matching processing unit 23 performs the stereo matching on the initial frame image, and then periodically performs the stereo matching, for example, on every 30 frames. The processing result of the stereo matching is maintained in the matching processing unit 23 and the previous processing result of the stereo matching is used until the subsequent stereo matching is performed.

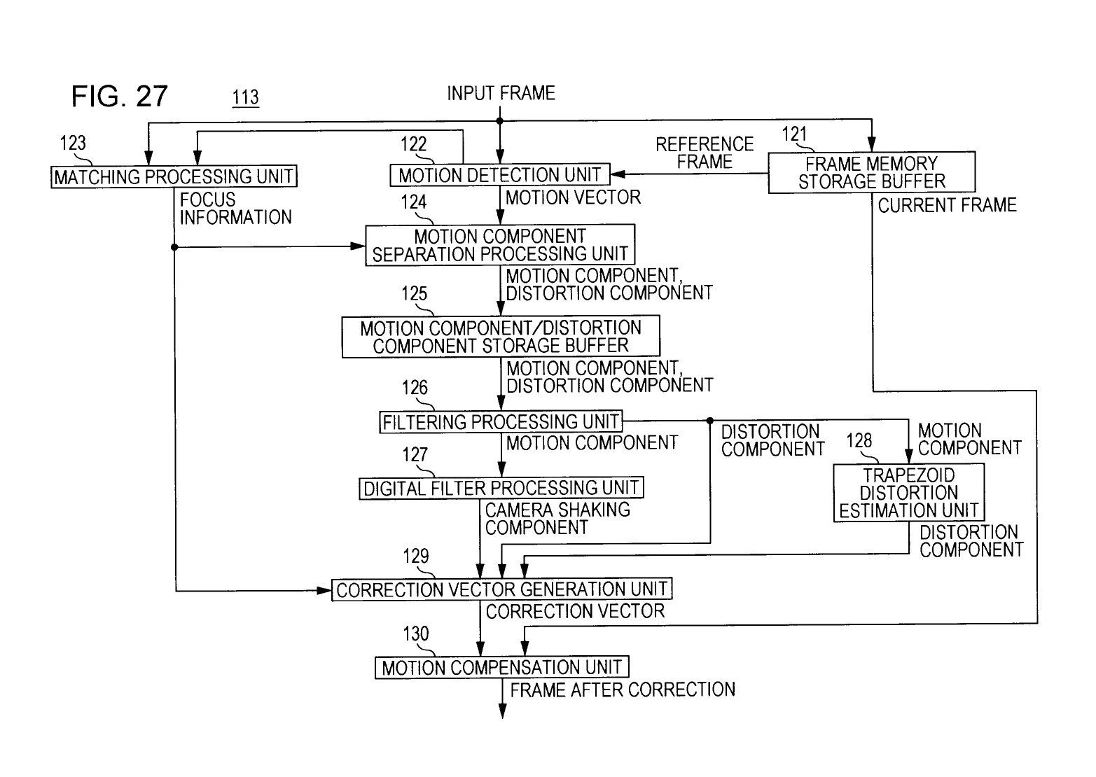

For example, as shown in FIG. 27, in an image processing unit 113, information regarding the motion vector is supplied from the motion detection unit 122 to the matching processing unit 123. In addition, the matching processing unit 123 performs the stereo matching on the initial frame image. Thereafter, when the motion vector detected by the motion detection unit 122 shows a motion corresponding to a value equal to or greater than a threshold value, for example, when the motion amount of the center point of a screen is calculated by affine transform and the motion vector moves 1/10 or more of the screen in the X axis direction or the Y axis direction, the matching processing unit 123 performs the stereo matching. When the motion vector does not show the motion corresponding to the value equal to or greater than the threshold value, the matching processing unit 123 maintains the processing result of the previous stereo matching and the matching processing unit 123 uses the processing result of the previous stereo matching until the subsequent stereo matching is performed.

For example, the matching processing unit 23 performs the stereo matching on the initial frame image, and then again performs the stereo matching until a scene is changed. In this case, a scene change detector (not shown) is separately provided. An input video is input to the scene change detector and a scene change flag is output toward the matching processing unit 23.

For example, in a case where the input video is encoded according to MPEG (Moving Picture Experts Group), the matching processing unit 23 performs the stereo matching when a picture type is an intra frame.

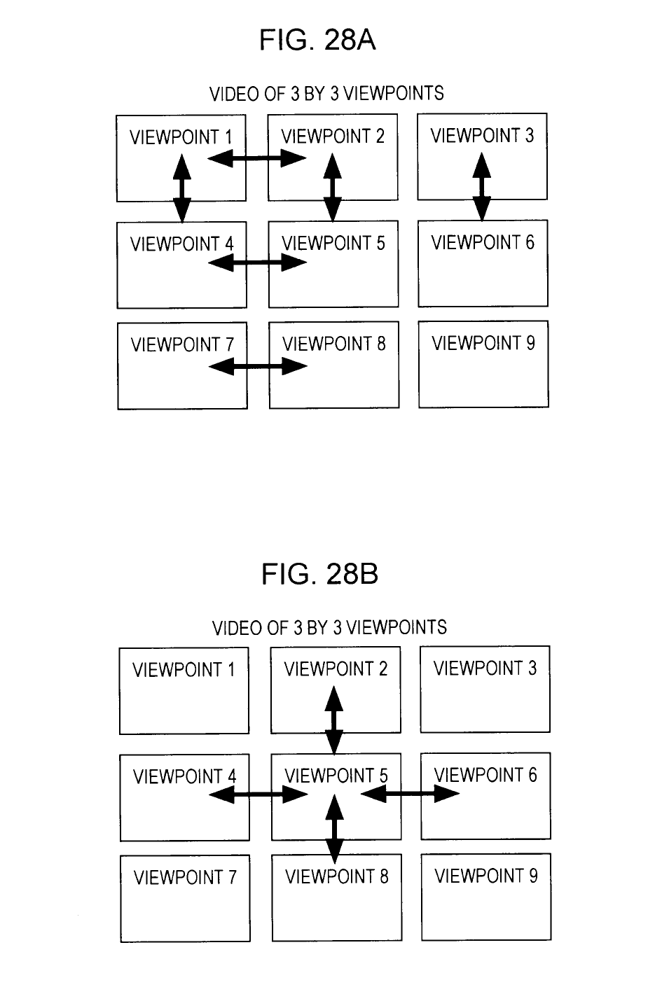

In the above-described first embodiment, as for the matching process, the matching processing unit 23 may attempt to improve the reliability of the matching processing result using the processing result of the stereo matching of the same positional relationship in the longitudinal direction and the transverse direction, as shown in FIG. 28A. For example, when there are N matching processing results of the same positional relationship, the maximum value and the minimum value are excluded from the N matching processing results. By averaging the remaining values and overwriting all of the matching processing results with the average value, the error detection ratio can be reduced. For example, the dispersion value of the matching processing results of the same positional relationship is calculated, and the matching processing results are overwritten with the average value when the dispersion value is smaller than a threshold value. However, when the dispersion value is larger than the threshold value, the error detection ratio can be reduced by performing no process.

In the above-described first embodiment, the matching processing unit 23 acquires the relative positional relationship in the longitudinal direction and the transverse direction of the video data of all viewpoints in two pieces of video data forming the processing target frame image. However, as shown in FIG. 28B, the stereo matching is performed only for the viewpoints in the vicinity of the center and the stereo matching between the other viewpoints may be estimated using the processing result of the stereo matching performed for the viewpoints in the vicinity of the center. As shown in FIG. 28B, in a case of 3 by 1 viewpoints, the stereo matching is performed between the viewpoints indicated by the arrows in the drawing. For example, the distance between viewpoints 1 and 2 is estimated using the result for viewpoints 4 and 5.

In the above-described first embodiment, the motion component separation processing unit 24 may use the Helmert transform. In this case, when the origin in the Helmert transform is calculated, the focus information of each viewpoint calculated by the matching processing unit 23 is used.

In the above-described first embodiment, the motion component separation processing unit 24 may not perform the component separation on the global motion vector GMV determined in each frame image, but may perform the component separation dynamically every time to determine the global motion vector GMV. In this case, for example, the component separation may be performed for the global motion vector GMV with the highest reliability among the global motion vectors GMV.

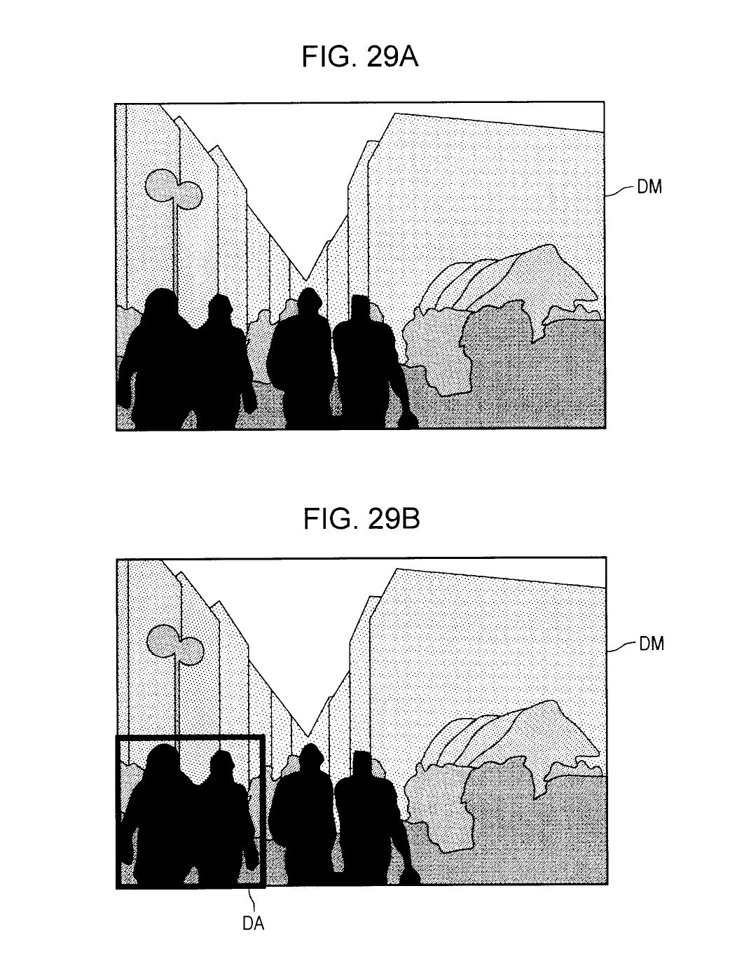

In the above-described first embodiment, the processing result of the stereo matching is used only in the background region. However, when a depth map DM such as in FIG. 29A is obtained, the processes of the motion component separation processing unit 24 to the correction vector generation unit 29 are performed on each of the same depth region and the motion compensation unit 30 synthesizes the respective depth regions. That is, the processes of the motion component separation processing unit 24 to the correction vector generation unit 29 are performed by the number of viewpoints×the number of the depth regions in about one frame image.

For example, in a depth region DA (for convenience sake, the depth region is indicated by a rectangular shape, but the depth region has not a rectangular shape but a human shape) shown in FIG. 29B, the process after the process of the motion component separation processing unit 24 is performed using the processing result (image distance) of the stereo matching calculated for the depth region DA. Moreover, in the stereo matching, the focus information is generated using the center of the depth region as the origin. The motion compensation unit 30 sequentially performs the process from the inside of the depth region in a superimposed manner. In addition, the motion compensation unit 30 finally performs an in-painting process or the like to bury a blank region (which is a region which is not filled with a pixel value) present in the frame buffer.

### 2. Other Embodiments

In the above-described first embodiment, the camera shaking amount Mₛ has been calculated using the camera motion component CM to correct the camera shaking. However, the invention is not limited thereto, and there is no restraint on the usage method of the camera motion component CM. For example, the quality of the frame image data can be improved by specifying the corresponding pixels using the camera motion component CM and using the corresponding pixels in a linear interpolation process.

In the above-described first embodiment, the camera motion component CM has been modeled into the translation element EMa, the rotation element EMb, and the zoom element EMc. However, the invention is not limited thereto. For example, the camera motion component CM may be modeled into the translation element EMa and the zoom element EMc. Moreover, the rotation element EMb may express the angle variation of three directions.

In the above-described first embodiment, the frame image has been corrected using the correction vector Vc which is based on the camera motion component CM. However, the invention is not limited thereto. The frame image may be corrected by various methods such as use of a correction coefficient.

In the above-described first embodiment, both the camera motion component CM and the focal plane distortion component CF have been calculated by Expression (11). However, the invention is not limited thereto. At least, the camera motion component CM may be calculated.

In the above-described first embodiment, the component separation expression is expressed by the determinant. However, the invention is not limited thereto. A general equation may be used to express the component separation expression.

In the above-described first embodiment, the origin correction matrix MC1 has been multiplied before the rotation element EMb and the origin correction inverse matrix MC2 has been multiplied after the rotation element EMb. However, the invention is not limited thereto. This process may not be necessarily performed. For example, when the origin is initially located at the center or near the center, this process may be omitted.

In the above-described first embodiment, the aspect ratio correction matrix MP1 has been multiplied before the rotation element EMb and the aspect ratio correction matrix MP2 has been multiplied after the rotation element EMb. However, the invention is not limited thereto. This process may not be necessarily performed. For example, when the aspect ratio is initially 1:1 or nearly 1:1, this process may be omitted.

In the above-described first embodiment, the filtering processing unit 26 has separated the focal plane distortion component CF and the camera motion component CM based on the reliability information. However, the invention is not limited thereto. The filtering process may not be necessarily performed. This filtering process may be performed on one of the focal plane distortion component CF and the camera motion component CM. Moreover, the motion detection unit 22 may set the sum value of the reliability indexes as the reliability information.

In the above-described first embodiment, the camera work component CMc has been generated from the camera motion component CM by the LPF processing. However, the invention is not limited thereto. The camera work component CMc may be generated by other various methods.

In the above-described first embodiment, the frame image data supplied from the camcorder has been corrected in advance for the camera shaking. However, the invention is not limited thereto. There is no restraint on whether the camera shaking is corrected in the frame image data.

In the above-described first embodiment, the image processing terminal 10 serving as an information processing apparatus has performed the image processing according to the embodiment of the invention. However, the invention is not limited thereto. An imaging apparatus having an imaging function may perform the image processing according to the embodiment of the invention. Accordingly, a hardware sensor may be omitted from the image processing apparatus. Moreover, a hardware sensor and the image processing according to the embodiment of the invention may be combined. For example, the image processing according to the first embodiment may be performed while only the angle variation of the yaw direction and the pitch direction are physically corrected by a gyro sensor.

In the above-described first embodiment, the image processing program or the like has been stored in advance in a ROM or a hard disk drive. However, the invention is not limited thereto. The image processing program may be installed in a flash memory or the like from an external storage medium such as a memory stick (trademark of Sony Corporation). Moreover, the image processing program or the like may be acquired from the outside via a USB (Universal Serial Bus), the Ethernet (trademark), or a wireless LAN (Local Area Network) such as IEEE (Institute of Electrical and Electronics Engineers) 802.11a/b/g. Moreover, the image processing program or the like may be delivered by the terrestrial digital television broadcasting or the BS digital television broadcasting.

In the above-described first embodiment, the camcorder has been used as a camera which images a subject as the video data. However, the invention is not limited thereto. For example, a moving image function of an internal camera of a cellular phone or a digital still camera may be used as a camera.

In the above-described first embodiment, the motion detection unit 22 serving as a motion detecting unit and the motion component separation processing unit 24 serving as a modeling unit and a component calculation unit are included in the image processing unit 13 serving as an image processing apparatus. However, the invention is not limited thereto. The motion detection unit, the modeling unit, and the component calculation unit formed by the other variation configurations may be included in the image processing apparatus according to the embodiment of the invention.

The present application contains subject matter related to that disclosed in Japanese Priority Patent Application JP 2010-082045 filed in the Japan Patent Office on Mar. 31, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a matching processing unit calculating positions of center coordinates of all video data forming one frame image of multi-viewpoint video data with respect to coordinates of the origin of the one frame image using at least two pieces of video data forming the one frame image, and generating focus information as the calculation result;
a motion vector detection unit detecting a motion vector, which indicates an overall motion of the one frame image, using one piece of video data of at least two pieces of video data forming the one frame image;
a motion component separation processing unit separating motion components of the one frame image using the focus information generated by the matching processing unit and the motion vector detected by the motion vector detection unit; and
a correction unit correcting all of the video data forming the one frame image using the motion components separated by the motion component separation processing unit.

2. The image processing apparatus according to claim 1, wherein the matching processing unit calculates positions of center coordinates of all video data forming the one frame image with respect to the coordinates of the origin of the one frame image using central video data of at least two pieces of video data forming the one frame image and video data adjacent to the central video data, and generates the focus information as the calculation result.

3. The image processing apparatus according to claim 1, wherein the matching processing unit calculates positions of center coordinates of all video data forming the one frame image with respect to the coordinates of the origin of the one frame image, using all of the video data forming the one frame image, and generates the focus information based on a positional relationship between the calculation result and all of the video data.

4. The image processing apparatus according to claim 1, wherein the matching processing unit generates the focus information at a predetermined frame interval.

5. The image processing apparatus according to claim 1, wherein the matching processing unit generates the focus information using the motion vector detected by the motion vector detection unit, when a motion amount which is based on the motion vector exceeds a given threshold value.

6. The image processing apparatus according to claim 1, wherein the matching processing unit generates the focus information when a scene change detection unit detects a scene change in the video data.

7. The image processing apparatus according to claim 1, wherein in a case where the video data is encoded, the matching processing unit generates the focus information, when a picture type of the video data is a predetermined picture type.

8. The image processing apparatus according to claim 1, wherein the motion component separation processing unit separates the motion components of the one frame image using a motion vector with the highest reliability among the motion vectors detected by the motion vector detection unit.

9. The image processing apparatus according to claim 1,
wherein the matching processing unit performs stereo matching using at least two video data forming the one frame image of the multi-viewpoint video data, calculates a position of center coordinates of the same depth region in all of the video data forming the one frame image with respect to the coordinates of the origin of the one frame image when a depth map is obtained as the result of the stereo matching, and generates the focus information as the calculation result,
wherein the motion component separation processing unit separates motion components of the same depth region using the focus information generated by the matching processing unit and the motion vector detected by the motion vector detection unit, and
wherein the correction unit corrects the same depth region in all of the video data forming the one frame image using the motion components separated by the motion component separation processing unit.

10. The image processing apparatus according to claim 1, wherein the motion component separation processing unit includes
a modeling unit modeling the motion vector detected by the motion vector detection unit into a component separation expression, in which a camera motion component and a focal plane distortion component are separated, using unknown component parameters respectively indicating a camera motion which is a motion of a camera and variation amounts of focal plane distortion, and
a component calculation unit calculating the camera motion component of the motion vector by calculating the component parameters used in the component separation expression.

11. The image processing apparatus according to claim 10, wherein the modeling unit models the motion vector into an expression below,
$$( \begin{matrix}{x}_{1} \\ {y}_{1} \\ 1\end{matrix} ) = ( \begin{matrix}{A}_{1} & {A}_{2} & {A}_{0} \\ {B}_{1} & {B}_{2} & {B}_{0} \\ 0 & 0 & 1\end{matrix} ) ( \begin{matrix}{x}_{0} \\ {y}_{0} \\ 1\end{matrix} ) = ( \begin{matrix}1 & 0 & {h}_{c} \\ 0 & 1 & {v}_{c} \\ 0 & 0 & 1\end{matrix} ) ( \begin{matrix}\frac{1}{p} & 0 & 0 \\ 0 & 1 & 0 \\ 0 & 0 & 1\end{matrix} ) ( \begin{matrix}1 & 0 & 0 \\ 0 & e & 0 \\ 0 & 0 & 1\end{matrix} ) ( \begin{matrix}1 & b & 0 \\ 0 & 1 & 0 \\ 0 & 0 & 1\end{matrix} ) ( \begin{matrix}1 & 0 & h \\ 0 & 1 & v \\ 0 & 0 & 1\end{matrix} ) ( \begin{matrix}cos θ & - sin θ & 0 \\ sin θ & cos θ & 0 \\ 0 & 0 & 1\end{matrix} ) ( \begin{matrix}s & 0 & 0 \\ 0 & s & 0 \\ 0 & 0 & 1\end{matrix} ) ( \begin{matrix}p & 0 & 0 \\ 0 & 1 & 0 \\ 0 & 0 & 1\end{matrix} ) ( \begin{matrix}1 & 0 & - {h}_{c} \\ 0 & 1 & - {v}_{c} \\ 0 & 0 & 1\end{matrix} ) ( \begin{matrix}{x}_{0} \\ {y}_{0} \\ 1\end{matrix} ) \qquad ( 1 )$$

12. The image processing apparatus according to claim 1, wherein the correction unit includes
a camera work component calculation unit calculating a camera work component indicating a user's intended motion of a camera based on a camera motion component,
a shaking amount calculation unit calculating a shaking amount by subtracting the camera work component from the camera motion component,
a correction vector generation unit generating a correction vector used to correct shaking in the motion vector based on the shaking amount calculated by the shaking amount calculation unit, and
a motion compensation unit applying the correction vector generated by the correction vector generation unit to the motion vector.

13. The image processing apparatus according to claim 12, wherein the modeling unit expresses the camera motion component and a focal plane distortion component as a determinant.

14. The image processing apparatus according to claim 13, wherein the correction vector generation unit generates a determinant including an inverse matrix of the shaking amount as the correction vector.

15. The image processing apparatus according to claim 14, wherein the correction unit further includes
a focal plane distortion correction amount calculation unit which calculates a focal plane distortion correction amount used to correct the frame image based on the focal plane distortion component calculated by the component calculation unit,
wherein the correction vector generation unit generates a determinant including an inverse matrix of the focal plane distortion correction amount as the correction vector.

16. The image processing apparatus according to claim 15, wherein the modeling unit multiplies an origin correction matrix, which moves the origin based on the focus information, before the rotation element and multiplies an origin correction inverse matrix, which returns the origin to a position before the movement, after the rotation element.

17. The image processing apparatus according to claim 16, wherein an aspect ratio correction matrix, which changes an aspect ratio of pixels to 1:1, is multiplied before the rotation element and an aspect ratio correction inverse matrix, which returns the pixels to a base aspect ratio, is multiplied after the rotation element.

18. The image processing apparatus according to claim 17, wherein on the assumption that the correction vector is Vc, the origin correction matrix is C, the aspect ratio correction matrix is P, an inverse matrix of the shaking amount is Mₛ⁻¹, an inverse matrix of the focal plane distortion correction amount is F⁻¹, the origin correction inverse matrix is C⁻¹, and the aspect ratio correction inverse matrix is P⁻¹, the correction vector generation unit generates the correction vector by an expression below,
Vc=C⁻¹P⁻¹Mₛ⁻¹F⁻¹PC.

19. An image processing method comprising the steps of:
calculating positions of center coordinates of all video data forming one frame image of multi-viewpoint video data with respect to coordinates of the origin of the one frame image using at least two pieces of video data forming the one frame image, and generating focus information as the calculation result;
detecting a motion vector, which indicates an overall motion of the one frame image, using one piece of video data of at least two pieces of video data forming the one frame image;
separating motion components of the one frame image using the focus information generated in the step of generating the focus information and the motion vector detected in the step of detecting motion vector; and
correcting all of the video data forming the one frame image using the motion components separated in the step of separating the motion components of the one frame image.

20. An image processing program causing a computer to execute the steps of:
calculating positions of center coordinates of all video data forming one frame image of multi-viewpoint video data with respect to coordinates of the origin of the one frame image using at least two pieces of video data forming the one frame image, and generating focus information as the calculation result;
detecting a motion vector, which indicates an overall motion of the one frame image, using one piece of video data of at least two pieces of video data forming the one frame image;
separating motion components of the one frame image using the focus information generated in the step of generating the focus information and the motion vector detected in the step of detecting motion vector; and
correcting all of the video data forming the one frame image using the motion components separated in the step of separating the motion components of the one frame image.
